(19) United States
(12) Patent Application Publication
(10) Pub. No.: US 2021/0212004 A1
(43) Pub. Date: Jul. 8, 2021

(54) SYNCHRONIZATION INDICATION METHOD, TERMINAL DEVICE AND NETWORK DEVICE

(71) Applicant: GUANDONG OPPO MOBILE TELECOMMUNICATIONS CORP., LTD., Dongguan (CN)

(72) Inventors: Qianxi LU, Dongguan (CN); Xin You, Dongguan (CN)

(73) Assignee: GUANGDONG OPPO MOBILE TELECOMMUNICATIONS CORP., LTD., Dongguan (CN)

(21) Appl. No.: 17/203,304

(22) Filed: Mar. 16, 2021

Related U.S. Application Data
(63) Continuation of application No. PCT/CN2018/109724, filed on Oct. 10, 2018.

(51) Int. Cl. H04W 56/00

(52) U.S. Cl. CPC H04W 56/001; H04W 56/0045

(57) ABSTRACT

The present application provides a synchronization indication method, a terminal device, a network device, a chip, a computer readable storage medium, a computer program product, and a computer program, which may include: receiving synchronization indication information sent by a source network device; where the synchronization indication information is configured to assist the terminal device in acquiring at least one of the following: a timing advance TA value between the terminal device and the source network device; a TA value between the terminal device and a target network device; or a difference between a TA between the terminal device and the source network device and a TA between the terminal device and the target network device.

### CROSS-REFERENCE TO RELATED APPLICATIONS

This application is a continuation of International Application No. PCT/CN2018/109724, filed on Oct. 10, 2018, the content of which is hereby incorporated by reference in its entirety.

### TECHNICAL FIELD

The present application relates to the field of information processing technologies, and in particular, to a synchronization indication method, a terminal device, a network device, a chip, a computer readable storage medium, a computer program product, and a computer program.

### BACKGROUND

In a handover process of mobile communication processing, after a user receives a radio resource control (RRC) configuration message, a Packet Data Convergence Protocol (PDCP) layer/a Radio Link Control (RLC) layer/a Media Access Control (MAC) layer/a lower layer or the like is reconfigured as a stack of a corresponding target network device according to a handover configuration. Meanwhile, uplink (UL)/downlink (DL) data transceiving at a source network device is stopped. However, in a scenario where handover is performed between different network devices or between different frequencies, such as inter-eNB and inter-freq terminal devices, a difference of TA may be different between a terminal device and a network device. Therefore, how to deal with synchronization is a problem that needs to be solved.

### SUMMARY

To solve the above technical problem, embodiments of the present application provides a synchronization indication method, a terminal device, a network device, a chip, a computer readable storage medium, a computer program product, and a computer program.

According to a first aspect, an embodiment of the present application provides a synchronization indication method, which is applied to a terminal device, including:

receiving synchronization indication information sent by a source network device;

where the synchronization indication information is configured to assist the terminal device in acquiring at least one of the following:

a timing advance TA value between the terminal device and the source network device; a TA value between the terminal device and a target network device; or a difference between a TA between the terminal device and the source network device and a TA between the terminal device and the target network device.

According to a second aspect, an embodiment of the present application provides a synchronization indication method, which is applied to a terminal device, including:

sending synchronization indication information to a network device;

where the synchronization indication information is configured to assist the network device in acquiring at least one of the following:

a timing advance TA value between the terminal device and a source network device; a TA value between the terminal device and a target network device; or a difference between a TA between the terminal device and the source network device and a TA between the terminal device and the target network device.

According to a third aspect, an embodiment of the present application provides a synchronization indication method, which is applied to a network device, including:

receiving synchronization indication information sent by a terminal device;

where the synchronization indication information is configured to assist the network device in acquiring at least one of the following:

a timing advance TA value between the terminal device and a source network device; a TA value between the terminal device and a target network device; or a difference between a TA between the terminal device and the source network device and a TA between the terminal device and the target network device.

According to a fourth aspect, an embodiment of the present application provides a synchronization indication method, which is applied to a network device, including:

sending synchronization indication information to a terminal device;

where the synchronization indication information is configured to assist the terminal device in acquiring at least one of the following:

a timing advance TA value between the terminal device and a source network device; a TA value between the terminal device and a target network device; or a difference between a TA between the terminal device and the source network device and a TA between the terminal device and the target network device.

According to a fifth aspect, an embodiment of the present application provides a synchronization indication method, which is applied to a network device, including:

sending synchronization indication information to a terminal device;

where the synchronization indication information is configured to configure the terminal device to measure a candidate target network device, so as to assist the network device in acquiring at least one of the following:

a timing advance TA value between the terminal device and a source network device; a TA value between the terminal device and the candidate target network device; or a difference between a TA between the terminal device and the source network device and a TA between the terminal device and the candidate target network device.

According to a sixth aspect, an embodiment of the present application provides a synchronization indication method, which is applied to a terminal device, including:

receiving synchronization indication information sent by a network device;

where the synchronization indication information is configured to configure the terminal device to measure a candidate target network device, so as to assist the network device in acquiring at least one of the following:

a timing advance TA value between the terminal device and a source network device; a TA value between the terminal device and the candidate target network device; or a difference between a TA between the terminal device and the source network device and a TA between the terminal device and the candidate target network device.

According to a seventh aspect, an embodiment of the present application provides a terminal device, including:

a first communicating unit, configured to receive synchronization indication information sent by a source network device;

where the synchronization indication information is configured to assist the terminal device in acquiring at least one of the following:

a timing advance TA value between the terminal device and the source network device; a TA value between the terminal device and a target network device; or a difference between a TA between the terminal device and the source network device and a TA between the terminal device and the target network device.

According to an eighth aspect, an embodiment of the present application provides a terminal device, including:

a second communicating unit, configured to send synchronization indication information to a network device;

where the synchronization indication information is configured to assist the network device in acquiring at least one of the following:

a timing advance TA value between the terminal device and a source network device; a TA value between the terminal device and a target network device; or a difference between a TA between the terminal device and the source network device and a TA between the terminal device and the target network device.

According to a ninth aspect, an embodiment of the present application provides a network device, including:

a third communicating unit, configured to receive synchronization indication information sent by a terminal device;

where the synchronization indication information is configured to assist the network device in acquiring at least one of the following:

a timing advance TA value between the terminal device and a source network device; a TA value between the terminal device and a target network device; or a difference between a TA between the terminal device and the source network device and a TA between the terminal device and the target network device.

According to a tenth aspect, an embodiment of the present application provides a network device, including:

a fourth communicating unit, configured to send synchronization indication information to a terminal device;

where the synchronization indication information is configured to assist the terminal device in acquiring at least one of the following:

a timing advance TA value between the terminal device and a source network device; a TA value between the terminal device and a target network device; or a difference between a TA between the terminal device and the source network device and a TA between the terminal device and the target network device.

According to a eleventh aspect, an embodiment of the present application provides a network device, including:

a fifth communicating unit, configured to send synchronization indication information to a terminal device;

where the synchronization indication information is configured to configure the terminal device to measure a candidate target network device, so as to assist the network device in acquiring at least one of the following:

a timing advance TA value between the terminal device and a source network device; a TA value between the terminal device and the candidate target network device; or a difference between a TA between the terminal device and the source network device and a TA between the terminal device and the candidate target network device.

According to a twelfth aspect, an embodiment of the present application provides a terminal device, including:

a sixth communicating unit, configured to receive synchronization indication information sent by a network device;

where the synchronization indication information is configured to configure the terminal device to measure a candidate target network device, so as to assist the network device in acquiring at least one of the following:

a timing advance TA value between the terminal device and a source network device; a TA value between the terminal device and the candidate target network device; or a difference between a TA between the terminal device and the source network device and a TA between the terminal device and the candidate target network device.

According to a thirteenth aspect, an embodiment of the present application provides a terminal device, including a processor and a memory. The memory is configured to store a computer program, and the processor is configured to invoke and run the computer program stored in the memory, and execute the method according to the first aspect, the second aspect, the sixth aspect, or implementations thereof.

According to a fourteenth aspect, a network device is provided, including a processor and a memory. The memory is configured to store a computer program, and the processor is configured to invoke and run the computer program stored in the memory, and execute the method according to any one of the third aspect to the fifth aspect, or implementations thereof.

According to a fifteenth aspect, a chip is provided, which is configured to implement the method according to any one of the first aspect to the sixth aspect, or implementations thereof.

Specifically, the chip includes: a processor, configured to invoke and run a computer program from a memory, so as to cause a device equipped with the chip to execute the method according to any one of the first aspect to the sixth aspect or implementations thereof.

According to a sixteenth aspect, a computer readable storage medium is provided, which is configured to store a computer program, and the computer program is configured to cause a computer to execute the method according to any one of the first aspect to the sixth aspect or implementations thereof.

According to a seventeenth aspect, a computer program product is provided, including computer program instructions, and the computer program instructions cause a computer to execute the method according to any one of the first aspect to the sixth aspect or implementations thereof.

According to an eighteenth aspect, a computer program is provided, which, when being run on a computer, causes the computer to execute the method according to any one of the first aspect to the sixth aspect or implementations thereof.

According to the technical solutions in the embodiments of the present application, the synchronization indication information is acquired, and at least one of the TA value between the terminal device and the source network device, the TA value between the terminal device and the target network device or a difference of TA between the two is acquired according to assistance of the synchronization indication information. Thus, it can be ensured that a synchronization difference with the source network device and a synchronization difference with the target network device are acquired at the handover of the terminal device, and it is not necessary to communicate with a specified network device at a specified time.

### BRIEF DESCRIPTION OF DRAWINGS

FIG. 1 is a first schematic view of architecture of a communication system according to an embodiment of the present application;

FIG. 2 is a first schematic flowchart of a synchronization indication method according to an embodiment of the present application;

FIG. 3 is a schematic view of a handover processing scenario according to an embodiment of the present application;

FIG. 4 is a second schematic flowchart of a synchronization indication method according to an embodiment of the present application:

FIG. 5 is a third schematic flowchart of a synchronization indication method according to an embodiment of the present application:

FIG. 6 is a fourth schematic flowchart of a synchronization indication method according to an embodiment of the present application:

FIG. 7 is a schematic structural diagram of a terminal device according to an embodiment of the present application;

FIG. 8 is a schematic structural diagram of a network device according to an embodiment of the present application;

FIG. 9 is a schematic structural diagram of a communication device according to an embodiment of the present application;

FIG. 10 is a schematic diagram of a chip according to an embodiment of the present application; and

FIG. 11 is a second schematic view of architecture of the communication system according to an embodiment of the present application.

### DESCRIPTION OF EMBODIMENTS

Hereinafter, the technical solution in embodiments of the present application will be described with reference to the accompanying drawings in the embodiments of the present application. Apparently, the described embodiments are a part of the embodiments of the present application, rather than all of the embodiments. Based on the embodiments of the present application, all other embodiments obtained by a person of ordinary skill in the art without paying creative efforts all belong to the protection scope of the present application.

The technical solution in the embodiments of the present application may be applied to various communication systems. For example, a Global System of Mobile communication (GSM), a Code Division Multiple Access (CDMA) system, a Wideband Code Division Multiple Access (WCDMA) system, General Packet Radio Service (GPRS) system, a Long Term Evolution (LTE) system, an LTE Frequency Division Duplex (FDD) system, LTE Time Division Duplex (TDD) system, a Universal Mobile Telecommunication System (UMTS), a Worldwide Interoperability for Microwave Access (WiMAX) communication system or a 5G system, etc.

Illustratively, a communication system 100 to which an embodiment of the present application is applied may be shown in FIG. 1. The communication system 100 may include a network device 110. The network device 110 may be a device in communication with a terminal device 120 (or referred to as a communication terminal, or a terminal). The network device 110 may provide communication coverage for a specific geographic area and may communicate with the terminal device located within the coverage area. In an embodiment, the network device 110 may be a network device (Base Transceiver Station, BTS) in a GSM system or a CDMA system, it may also be a network device (Node B, NB) in a WCDMA system, it may also be an evolutional network device (Evolutional Node B, an eNB or a network device) in an LTE system, or it may be a wireless controller in a Cloud Radio Access Network (CRAN), or the network device may be a mobile switching center, a relay station, an access point, a vehicle-mounted device, a wearable device, a hub, a switch, a bridge, a router, a network-side device in a 5G network, or a network device in a future evolved Public Land Mobile Network (PLMN), etc.

The communication system 100 further includes at least one terminal device 120 within the coverage of the network device 110. The “terminal device” used herein includes, but is not limited to, an apparatus connected via a wired line, such as a Public Switched Telephone Network (PSTN), a Digital Subscriber Line (DSL), a digital cable, and a cable; and/or another data connection/network; and/or via a wireless interface, for example, for a cellular network, a Wireless Local Area Network (WLAN), a digital television network such as a DVB-H network, a satellite network, and an AM-FM broadcast transmitter; and/or another terminal device configured to receive/send a communication signal; and/or an Internet of Things (IoT) device. The terminal device configured to communicate through a wireless interface may be referred to as a “wireless communication terminal”, a “wireless terminal”, or a “mobile terminal”. Examples of the mobile terminal include, but are not limited to, a satellite telephone or a cellular telephone; a Personal Communications System (PCS) terminal that can combine a cellular radio telephone with capabilities of data processing, facsimile and data communication; a Personal Digital Assistant (PDA) that may include a radio telephone, a pager, an Internet/intranet access, a Web browser, a note, a calendar, and/or a Global Positioning System (Global Positioning System, GPS) receiver; as well as a conventional laptop and/or a palm receiver or other electronic devices that include a radio telephone transceiver. The terminal device may refer to an access terminal, a terminal device (User Equipment, User Equipment), a terminal device unit, a terminal device station, a mobile station, a mobile platform, a remote station, a remote terminal, a mobile device, a terminal device terminal, a terminal, a wireless communication device, a terminal device proxy, or a terminal device apparatus. The access terminal may be a cellular telephone, a cordless telephone, a Session Initiation Protocol (SIP) telephone, a Wireless Local Loop (WLL) station, a Personal Digital Assistant (PDA), a handheld device having a function of wireless communication, a computing device or other processing devices connected to a wireless modem, a vehicle-mounted device, a wearable device, a terminal device in the 5G network, or a terminal device in future evolved PLMN, etc.

In an embodiment, Device to Device (D2D) communication may be performed between terminal devices 120.

In an embodiment, the 5G system or the 5G network may also be referred to as a New Radio (NR) system or a NR network.

FIG. 1 illustratively shows one network device and two terminal devices. In an embodiment, the communication system 100 may include a plurality of network devices and other amount of terminal devices may be included in the coverage of each network device, which is not limited in the embodiment of the present application.

In an embodiment, the communication system 100 may further include other network entities such as a network controller and a mobile management entity, which is not limited in the embodiment of the present application.

It should be understood that, a device with a communication function in the network/system in the embodiment of the present application may be referred to as a communication device. The communication system 100 shown in FIG. 1 is taken as an example. The communication device may include the network device 110 with a communication function and the terminal device 120 with a communication function. The network device 110 and the terminal device 120 may be specific devices described above, which will not be described herein again. The communication device may further include other devices in the communication system 100 for example, other network entities such as the network controller and the mobile management entity, which is not limited in the embodiment of the present application.

It should be understood that, the terms “system” and “network” are often used interchangeably herein. The term “and/or” herein is merely an association relationship describing an associated object, and indicates that there may be three relationships. For example. A and/or B may indicate that there are three cases: A alone, A and B together, and B alone. In addition, the character “/” herein generally indicates that the front and back associated objects are of a “or” relationship.

In order to understand the features and technical contents of the embodiments of the present application in more detail, the implementation of the embodiments of the present application will be described in detail below with reference to the accompanying drawings. The accompanying drawings are merely used for description, and are not intended to limit the embodiments of the present application.

### Embodiment 1

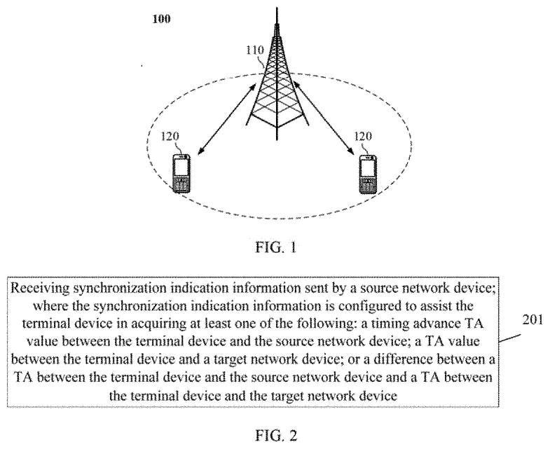

An embodiment of the present application provides a synchronization indication method, which is applied to a terminal device, as shown in FIG. 2, including:

Step 201: receiving synchronization indication information sent by a source network device;

where the synchronization indication information is configured to assist the terminal device in acquiring at least one of the following:

a timing advance TA value between the terminal device and the source network device; a TA value between the terminal device and a target network device; or a difference between a TA between the terminal device and the source network device and a TA between the terminal device and the target network device.

Regarding the synchronization indication information received by the terminal device, it may be carried in an RRC message. In the present embodiment, the synchronization indication information is sent by the source network device to the terminal device, that is, the synchronization indication information may be carried in the RRC message and sent to the terminal device.

The RRC message includes at least a reconfiguration message and a handover command. That is to say, the synchronization indication information may be sent by the network device to the terminal device, and then it may be sent to the terminal device in the RRC message, i.e. in the reconfiguration message and the handover command.

In the present embodiment, a measurement configuration may also be provided for the terminal device, and of course, the measurement configuration may not be provided for the terminal device. Correspondingly, when the measurement configuration is provided for the terminal device, the method further includes: performing a measurement based on the measurement configuration; and obtaining a measurement result, and reporting the measurement result to a network side, which may be specifically a source network device side of the network side. Furthermore, the source network device may determine, based on the measurement result, the difference between the TA between the terminal device and the source network device and the TA between the terminal device and the target network device.

The measurement result may include a measurement result for a reference signal of the source network device and a measurement result for a reference signal of at least one target network device.

It should be pointed out that, the RRC message may also be a new RRC message, which may be constituted by introducing a new measurement IE in the RRC message. The IE configures the measurement and is dedicated to the synchronization indication information, and may be specifically configured according to a practical situation. Details are not described herein again.

Regarding the measurement performed by the terminal device on the reference signal, the measurement may be performed on the reference signal sent by the source network device and/or the at least one target network device. For example, the reference signal may include at least one of the following: a cell identifier, a frequency identifier, a measurement ID, an allowed measurement bandwidth, an SSB, a CRS (a specific reference signal of a cell, also referred to as a common reference signal), an MBSFN-RS, a UE-specific RS (a specific reference signal of a mobile station), a PRS, or a CSI-RS, which are not exhaustively listed here.

In addition, the network side may use the new RRC message or RRC reconfiguration information to instruct a U to report a TA value at a source base station, or the recommended TA value, or a range of the recommended TA value.

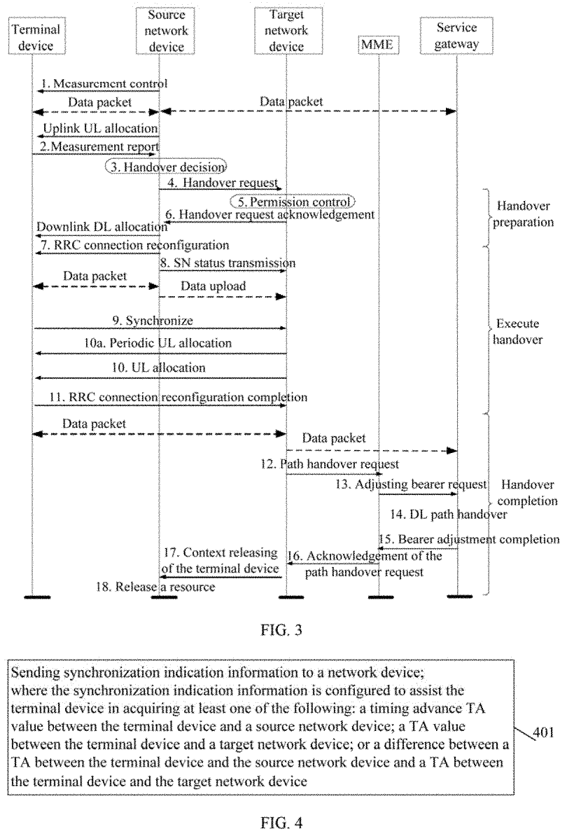

Regarding a handover process, reference may be made to FIG. 3, which includes a handover preparation stage, including steps 1-6 in the figure. The source network device sends measurement control to the terminal device, and the synchronization indication information may be included. After performing the measurement for a plurality of network devices or cells, the terminal device sends a measurement report to the source network device. The source network device makes a handover decision according to the measurement report (or in combination with RRM information). The source network device sends a handover request to the target network device to make the target network device ready for handover. The target network device performs handover permission control according to the handover request. When determining to perform a handover, the target network device sends a handover request acknowledgement to the source network device.

Then, a handover stage is executed, which includes steps 7-11 in the figure. Specifically, the target network device generates RRC information and sends RRC connection reconfiguration information to the source network device, thus the source network device sends the RRC connection reconfiguration information to the terminal device. After receiving the RRC connection reconfiguration information, the terminal device acquires the synchronization indication information according to the connection reconfiguration information, and executes handover processing. Then the source network device sends a SN status transmission to the target network device. The terminal device synchronizes with the target network device, and then receives a UL allocation performed by the target network device, and sends RRC connection reconfiguration completion information to the target network device.

Finally, it enters a handover completion stage, including steps 12-18 in the figure. Specifically, the target network device sends a path handover request to an MME to notify the MME that the terminal device changes a cell. The MME sends an adjusting bearer request to a service gateway, and the MME performs downlink path handover processing. After having completed the processing, the service gateway sends bearer adjustment completion processing to the MME, and the MME sends an acknowledgment message of the path handover request to the target network device. The target network device notifies the source network device of context releasing of the terminal device and a resource is released by the source network device.

On the basis of the above scenario, the synchronization indication information further includes at least one of the following:

a TA value of the terminal device on a target network device side; TA offset values of the terminal device at the source network device and the target network device; or a TA adjusting factor.

The synchronization indication information received by the terminal device from the network device may include the TA value of the terminal device at the target network device, which may be sent to the source network device by the target network device, thus may be sent by the source network device to the terminal device. Regarding the manner for acquiring the TA value by the target network device, reference may be made to the manner described above, which is not described herein again.

In the synchronization indication information, the TA offset value, that is, TA offset, may be an offset time indicated by a TA command. The TA offset value of the target network device may also be sent by the target network device to the source network device, and then the source network device sends the TA offset value of the target network device and a TA value of the source network device together to the terminal device.

The TA adjusting factor may be a value set on a network device side according to an actual situation, and it may include a TA adjusting factor corresponding to the target network device, and/or a TA adjusting factor of the source network device, where the TA adjusting factor corresponding to the target network device may be configured to calculate and obtain the TA value of the target network device based on the TA value of the source network device and the TA adjusting factor of the target network device.

In addition, the TA adjusting factor of the source network device may be configured to calculate and obtain the TA value of the source network device based on the TA value of the target network device and the TA adjusting factor of the source network device.

The TA adjusting factor of the target network device is taken as an example for description. The TA value of the source network device*the TA adjusting factor of the target network device=the TA value of the target network device. It should be understood that, a computing manner for the source network device is similar to that for the target network device, and will not be described herein again.

The method further includes:

receiving indication information sent by the source network device;

where the indication information includes at least one of the following:

a time boundary between the terminal device and the source network device and a time boundary between the terminal device and the target network device; or

a difference between a time boundary between the terminal device and the source network device and a time boundary between the terminal device and the target network device. Correspondingly, after the receiving indication information sent by the source network device, the method further includes:

determining, based on the indication information and/or the synchronization indication information, at least one of the following:

the timing advance TA value between the terminal device and the source network device; the TA value between the terminal device and the target network device; or the difference between the TA between the terminal device and the source network device and the TA between the terminal device and the target network device.

Specifically, the TA value between the terminal device and the target network device may be determined based on the indication information and/or the synchronization indication information.

On the basis, based on the TA value between the terminal device and the source network device and the TA value between the terminal device and the target network device, the difference between the TA between the terminal device and the source network device and the TA between the terminal device and the target network device may also be determined.

Further, when determining the difference of TA, one way is to use the indication information. For example, based on a difference value of the time boundary between the terminal device and the source network device and the time boundary between the terminal device and the target network device, the difference between the TA between the terminal device and the source network device and the TA between the terminal device and the target network device may be estimated, where the time boundary between the terminal device and the network device may be understood as a starting point of a radio frame.

For another example, the difference between the TA between the terminal device and the source network device and the TA between the terminal device and the target network device may be determined based on the difference between the time boundary between the terminal device and the source network device and the time boundary between the terminal device and the target network device.

The manner may be mainly applied to downlink synchronization.

Alternatively, another manner may be that the difference of TA is determined directly according to the synchronization indication information. For example, it may include at least one of the following:

acquiring the TA value of the terminal device at the target network device, and based on a self-detected TA value between the terminal device and the source network device, then calculating to obtain a difference of TA between the two:

calculating, according to the TA offset value of the terminal device at the source network device and the TA offset value of the terminal device at the target network device, a difference between the two, which is taken as the difference of TA; or

calculating to obtain the TA value of the target network device based on the TA adjusting factor corresponding to the target network device, and determining the difference of TA between the two in combination with the TA of the target network device and the TA value of the source network device; and/or, determining the TA value of the source network device based on the TA adjusting factor of the source network device, and determining the difference of TA between the two in combination with the TA value of the source network device and the TA value of the target network device.

In another manner, the difference of TA is determined in combination with the synchronization indication information and the indication information, and the foregoing two processing manners may be used in combination. For example, the manner may include:

based on the time boundary between the terminal device and the source network device and the time boundary between the terminal device and the target network device, in combination with the TA value of the terminal device at the target network device in the synchronization indication information, and then according to the self-detected TA value between the terminal device and the source network device, calculating to obtain the difference of TA between the two.

Alternatively, based on the difference between the time boundary between the terminal device and the source network device and the time boundary between the terminal device and the target network device, in combination with the TA adjusting factor corresponding to the target network device, calculating to obtain the TA value of the target network device, then in combination with the TA of the target network device and the TA value of the source network device, determining the difference of TA between the two; and/or determining the TA value of the source network device based on the TA adjusting factor of the source network device, and determining the difference of TA between the two in combination with the TA value of the source network device and the TA value of the target network device.

Certainly, there may be other combination manners, which are not exhaustively listed here. Furthermore, it can also be understood that, after the aforementioned TA values are determined, the difference of TA may be further determined, or merely the TA values are acquired without calculating the difference of TA. It may be set in a specific implementation according to an actual situation, which is not limited in the present embodiment.

In addition, it should be noted that, the timing advance (TA, timing advance) may be used for uplink transmission, which means that in order to make an uplink packet arrive at the network device at a desired time, a radio frequency transmission delay caused by a distance is estimated and a data packet is sent in advance at a corresponding time. In order to ensure time synchronization on the network device side, the LTE proposes a mechanism of Uplink Timing Advance. From the perspective of the terminal device side, the TA is essentially a negative offset between a start moment for receiving a downlink sub-frame and a moment for transmitting an uplink sub-frame. By appropriately controlling an offset of each terminal device, the network device can control the time when uplink signals from different terminal devices reach the network device. For a terminal device remote from the network device, since there is a large transmission delay, uplink data is sent earlier than a terminal device close to the network device. Regarding how to acquire the TA in the uplink transmission, the TA value of each terminal device may be determined by the network device through measuring the uplink transmission of the terminal device. It can be understood that, as long as the terminal device has the uplink transmission, the network device may be configured to estimate the TA value.

The present embodiment may be applied to a plurality of scenarios. It may be any handover scenarios in which the TAs between the terminal device and the source network device/the target network device are different. For example, a handover occurs between network devices, or cells in the network device but at different frequencies, or between other network devices which are not synchronized.

Certainly, it may also be a situation that the terminal device in handover processing can acquire a plurality of candidate target network devices (or candidate target cells). In this case, the plurality of candidate target network devices may be sent to the terminal device by the source network device. The terminal device selects one target network device to initiate the handover processing each time. That is, the target network device in the embodiment may be one of at least one candidate target network device.

It may also be a scenario in which two sets of protocol stacks are maintained. The terminal device retains a first protocol stack and a first related key with the source network device, and maintains a second protocol stack and a second related key with a first target network device; and

the first related key is different from the second related key.

The first protocol stack and the second protocol stack may be the same or different, or at least partially different. For example, when aiming at the SG system, different Service Data Adaptation Protocols (SDAP), different Packet Data Convergence Protocols (PDCP), different Radio Link Control (RLC) protocols, different Media Access Control (MAC) entities and different Low layer entities may be maintained between the terminal device and the source network device, and between the terminal device and the first target network device. When aiming at a 4G system, different Packet Data Convergence Protocols (PDCP), different Radio Link Control (RLC) protocols, different Media Access Control (MAC) entities and different Low layer entities may be maintained between the terminal device and the source network device, and between the terminal device and the first target network device. In addition, in the solution provided by the embodiment, in order to ensure that different keys are used, the PDCPs of the first protocol stack and the second protocol stack must be different. At least one of the SDAP, the RLC, the MAC or a physical layer may be the same or different. Alternatively, the first protocol stack and the second protocol stack may share at least one of the SDAP the RLC, the MAC or the physical layer, or may have the SDAP, the RLC, the MAC and the physical layer respectively.

It can clearly be seen that, by adopting the above solution, at least one of the TA value between the terminal device and the source network device, the TA value between the terminal device and the target network device or the difference of TA between the two is acquired according to assistance of the synchronization indication information. Thus, it can be ensured that a synchronization difference with the source network device and a synchronization difference with the target network device are acquired at the handover of the terminal device, and it is not necessary to communicate with a specified network device at a specified time.

### Embodiment 2

An embodiment of the present application provides a synchronization indication method, which is applied to a terminal device, as shown in FIG. 4, including:

Step 401: sending synchronization indication information to a network device;

where the synchronization indication information is configured to assist the terminal device in acquiring at least one of the following:

a timing advance TA value between the terminal device and a source network device; a TA value between the terminal device and a target network device; or a difference between a TA between the terminal device and the source network device and a TA between the terminal device and the target network device.

It should be noted that, in the present embodiment, the network device may be the source network device or the target network device. In other words, the terminal device may send the synchronization indication information to the source network device, or may send the synchronization indication information to the target network device.

Regarding the synchronization indication information, it may be carried in an RRC message, where the RRC message includes at least a measurement report message.

It should be understood that, when the measurement report message is included in the synchronization indication information, a measurement configuration sent by the source network device or the target network device on a network side may be received. A measurement is performed based on the measurement configuration; and a measurement result is obtained, and the measurement result is reported to the network side.

Correspondingly, the source network device or the target network device may determine the difference between the TA between the terminal device and the source network device and the TA between the terminal device and the target network device according to the measurement result.

The measurement result may include a measurement result for a reference signal of the source network device and a measurement result for a reference signal of at least one target network device.

Regarding the measurement performed by the terminal device on the reference signal, the measurement may be performed on the reference signal sent by the source network device and/or the at least one target network device. For example, the reference signal may include at least one of the following: a cell identifier, a frequency identifier, a measurement ID, an allowed measurement bandwidth, an SSB, a CRS (a specific reference signal of a cell, also referred to as a common reference signal), an MBSFN-RS, a UE-specific RS (a specific reference signal of a mobile station), a PRS, or a CSI-RS, which are not exhaustively listed here.

Regarding a handover process, reference may be made to FIG. 3, which includes a handover preparation stage, including steps 1-6 in the figure. The source network device sends measurement control to the terminal device. After performing measurement for a plurality of network devices or cells, the terminal device sends a measurement report to the source network device, and the synchronization indication information may be included therein. The source network device makes a handover decision according to the measurement report (or in combination with RRM information). The source network device sends a handover request to the target network device to make the target network device ready for handover. The target network device performs handover permission control according to the handover request. When determining to perform a handover, the target network device sends a handover request acknowledgement to the source network device.

Then, a handover stage is executed, which includes steps 7-11 in the figure. Specifically, the target network device generates RRC information and sends RRC connection reconfiguration information to the source network device, thus the source network device sends the RRC connection reconfiguration information to the terminal device. After receiving the RRC connection reconfiguration information, the terminal device acquires the synchronization indication information according to the connection reconfiguration information, and executes handover processing. Then the source network device sends a SN status transmission to the target network device. The terminal device synchronizes with the target network device, and then receives a UL allocation performed by the target network device, and sends RRC connection reconfiguration completion information to the target network device.

Finally, it enters a handover completion stage, including 12-18 in the figure. Specifically, the target network device sends a path handover request to an MME to notify the MME that the terminal device changes a cell. The MME sends an adjusting bearer request to a service gateway, and the MME performs downlink path handover processing. After having completed the processing, the service gateway sends bearer adjusting completion processing to the MME, and the MME sends an acknowledgment message of the path handover request to the target network device. The target network device notifies the source network device of context releasing for the terminal device and a resource is released by the source network device.

In addition, it should be noted that, the timing advance (TA, timing advance) may be used for uplink transmission, which means that in order to make an uplink packet arrive at the network device at a desired time, a radio frequency transmission delay caused by a distance is estimated and a data packet is sent in advance at a corresponding time. In order to ensure time synchronization on the network device side, the LTE proposes a mechanism of Uplink Timing Advance. From the perspective of the terminal device side, the TA is essentially a negative offset between a start moment for receiving a downlink sub-frame and a moment for transmitting an uplink sub-frame. By appropriately controlling an offset of each terminal device, the network device can control the time when uplink signals from different terminal devices reach the network device. For a terminal device remote from the network device, since there is a large transmission delay, uplink data is sent earlier than a terminal device close to the network device. Regarding how to acquire the TA in the uplink transmission, the TA value of each terminal device may be determined by the network device through measuring the uplink transmission of the terminal device. It can be understood that, as long as the terminal device has the uplink transmission, the network device may be configured to estimate the TA value.

On the basis of the above scenario, the synchronization indication information further includes at least one of the following:

a signal measurement difference of the terminal device at the source network device and the target network device; a difference between a distance between the terminal device and the source network device and a distance between the terminal device and the target network device; a difference between a path loss between the terminal device and the source network device and a path loss between the terminal device and the target network device; TA value information between the terminal device and the network device; an identifier of the target network device; or an identifier of a candidate target network device selected by the terminal device.

In addition, the synchronization indication information may further include a candidate target cell list in addition to the above information. The candidate target cell list includes but is not limited to at least one of the following: a cell ID, a measurement result (such as RSRP), positioning information, or path loss information.

Specifically, the synchronization indication information includes a measurement difference (such as RSRP) of the terminal device at the source network device and the target network device, or a distance difference (such as acquired according to a positioning reference signal) of the terminal device at the source 7z network device and the target network device, or recommended TA value information, such as a TA value with a source cell, or various combinations thereof.

The terminal device may measure to obtain a signal measurement result of the source network device, and obtain a signal measurement result of the target network device, and determine the signal measurement difference of the terminal device at the source network device and the target network device based on the two results.

Regarding the difference of the distance between the terminal device and the source network device and the distance between the terminal device and the target network device, it may be determined based on physical locations of the source network device and the target network device and a physical location of the terminal device. The manner in which the physical location of the network device is acquired may be preconfigured by the network side, or may also be requested from the network side, which is not limited here. The manner in which the physical location of the terminal device is determined may be determined according to a GPS module, of course, may also be determined according to the cell in which the terminal device is located, or the terminal device determines the location information according to measurement by virtue of a positioning reference signal, which is not exhaustively listed.

The TA value information between the terminal device and the network device may include at least one of the following: a TA value of the source network device, a TA offset value with the source network device, a TA offset value with the target network device, a TA value with the target network device, a TA adjusting factor with the target network device, or a TA adjusting factor with the source network device.

In addition, when the terminal device pre-acquires related information of at least one candidate target network device configured by the network side, the terminal device may directly notify the network side of identification information of the currently selected target network device when the handover fails or the handover is performed. In this case, it may be an identifier of the target network device selected by the terminal device for handover. Of course, several candidate target network devices with better communication quality may also be selected by the terminal device, and identifiers of the candidate target network devices are sent to the source network device, and the source network device selects the target network device for the terminal device. A better communication quality may be determined according to the measurement result of the reference signal, for example, a signal-to-noise ratio that is greater than a preset signal-to-noise ratio threshold, or top N (N is greater than or equal to 1 and less than or equal to the amount of all candidate network devices) in the sorted signal-to-noise ratios may be included. Of course, other parameters may also be used for measuring the communication quality. For example, other parameters may include a signal strength and a noise strength, and they may also be used in combination, which will not be exhaustively listed here, and it should be understood that, the selection manner is similar to the foregoing selection manner based on the signal-to-noise ratio, which will not be described herein again.

For the present embodiment, it may be applied to a plurality of scenarios. It may be any handover scenarios in which the TAs between the terminal device and the source network device/the target network device are different. For example, a handover occurs between network devices, or cells in the network device but at different frequencies, or between other network devices which are not synchronized.

Certainly, it may also be a situation that the terminal device in handover processing can acquire a plurality of candidate target network devices (or candidate target cells). In this case, the plurality of candidate target network devices may be sent to the terminal device by the source network device. The terminal device selects one target network device to initiate the handover processing each time. That is, the target network device in the embodiment may be one of at least one candidate target network device.

It may also be a scenario in which two sets of protocol stacks are maintained. The terminal device retains a first protocol stack and a first related key with the source network device, and maintains a second protocol stack and a second related key with a first target network device; and

the first related key is different from the second related key.

The first protocol stack and the second protocol stack may be the same or different, or at least partially different. For example, when aiming at the 5G system, different Service Data Adaptation Protocols (SDAP), different Packet Data Convergence Protocols (PDCP), different Radio Link Control (RLC) protocols, different Media Access Control (MAC) entities and different Low layer entities may be maintained between the terminal device and the source network device, and between the terminal device and the first target network device. When aiming at a 4G system, different Packet Data Convergence Protocols (PDCP), different Radio Link Control (RLC) protocols, different Media Access Control (MAC) entities and different Low layer entities may be maintained between the terminal device and the source network device, and between the terminal device and the first target network device. In addition, in the solution provided by the embodiment, in order to ensure that different keys are used, the PDCPs of the first protocol stack and the second protocol stack must be different. At least one of the SDAP the RLC, the MAC or a physical layer may be the same or different. Alternatively, the first protocol stack and the second protocol stack may share at least one of the SDAP, the RLC, the MAC or the physical layer, or may have the SDAP, the RLC, the MAC and the physical layer respectively.

It can clearly be seen that, by adopting the above solution, at least one of the TA value between the terminal device and the source network device, the TA value between the terminal device and the target network device or a difference of TA between the two is acquired according to assistance of the synchronization indication information. Thus, it can be ensured that a synchronization difference with the source network device and a synchronization difference with the target network device are acquired at the handover of the terminal device, and it is not necessary to communicate with a specified network device at a specified time.

### Embodiment 3

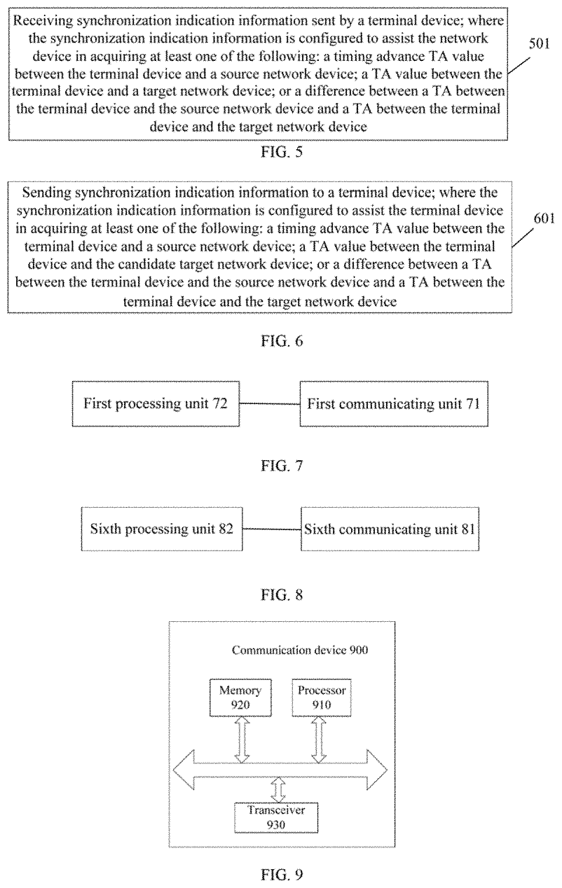

An embodiment of the present application provides a synchronization indication method, which is applied to a network device, as shown in FIG. 5, including:

Step 501: receiving synchronization indication information sent by a terminal device;

where the synchronization indication information is configured to assist the network device in acquiring at least one of the following:

a timing advance TA value between the terminal device and a source network device; a TA value between the terminal device and a target network device; or a difference between a TA between the terminal device and the source network device and a TA between the terminal device and the target network device.

Further, the present embodiment may further include: acquiring, based on the synchronization indication information, the difference between a timing advance (TA) between the terminal device and the source network device and the TA between the terminal device and the target network device.

It should be noted that, in the present embodiment, the network device may be the source network device or the target network device. In other words, the terminal device may send the synchronization indication information to the source network device, or may send the synchronization indication information to the target network device.

Regarding the synchronization indication information, it may be carried in an RRC message, where the RRC message includes at least a measurement report message.

It should be understood that, when the measurement report message is included in the synchronization indication information, a measurement configuration sent by the source network device or the target network device on a network side may be received. A measurement is performed based on the measurement configuration; and a measurement result is obtained, and the measurement result is reported to the network side.

Correspondingly, the network device, such as the source network device or the target network device, may determine the difference between the TA between the terminal device and the source network device and the TA between the terminal device and the target network device according to the measurement result in the measurement report message.

The measurement result may include a measurement result for a reference signal of the source network device and a measurement result for a reference signal of at least one target network device.

Regarding the measurement performed by the terminal device on the reference signal, the measurement may be performed on the reference signal sent by the source network device and/or the at least one target network device. For example, the reference signal may include at least one of the following: a cell identifier, a frequency identifier, a measurement ID, an allowed measurement bandwidth, an SSB, a CRS (a specific reference signal of a cell, also referred to as a common reference signal), an MBSFN-RS, a UE-specific RS (a specific reference signal of a mobile station), a PRS, or a CSI-RS, which are not exhaustively listed here.

In addition, it should be noted that, the timing advance (TA, timing advance) may be used for uplink transmission, which means that in order to make an uplink packet arrive at the network device at a desired time, a radio frequency transmission delay caused by a distance is estimated and a data packet is sent in advance at a corresponding time. In order to ensure time synchronization on the network device side, the LTE proposes a mechanism of Uplink Timing Advance. From the perspective of the terminal device side, the TA is essentially a negative offset between a start moment for receiving a downlink sub-frame and a moment for transmitting an uplink sub-frame. By appropriately controlling an offset of each terminal device, the network device can control the time when uplink signals from different terminal devices reach the network device. For a terminal device remote from the network device, since there is a large transmission delay, uplink data is sent earlier than a terminal device close to the network device. Regarding how to acquire the TA in the uplink transmission, the TA value of each terminal device may be determined by the network device through measuring the uplink transmission of the terminal device. It can be understood that, as long as the terminal device has the uplink transmission, the network device may be configured to estimate the TA value.

On the basis of the above scenario, the synchronization indication information further includes at least one of the following:

a signal measurement difference of the terminal device at the source network device and the target network device; a difference between a distance between the terminal device and the source network device and a distance between the terminal device and the target network device; a difference between a path loss between the terminal device and the source network device and a path loss between the terminal device and the target network device; TA value information between the terminal device and the network device; an identifier of the target network device; or an identifier of a candidate target network device selected by the terminal device.

In addition, the synchronization indication information may further include a candidate target cell list in addition to the above information. The candidate target cell list includes but is not limited to at least one of the following: a cell ID, a measurement result (such as RSRP), positioning information, or path loss information.

Specifically, the synchronization indication information includes a measurement difference (such as RSRP) of the terminal device at the source network device and the target network device, or a distance difference (such as acquired according to a positioning reference signal) of the terminal device at the source network device and the target network device, or recommended TA value information, such as a TA value with a source cell, or various combinations thereof.

The terminal device may measure to obtain a signal measurement result of the source network device, and obtain a signal measurement result of the target network device, and determine the signal measurement difference of the terminal device at the source network device and the target network device based on the two results.

Regarding the difference of the distance between the terminal device and the source network device and the distance between the terminal device and the target network device, it may be determined based on physical locations of the source network device and the target network device and a physical location of the terminal device. The manner in which the physical location of the network device is acquired may be preconfigured by the network side, or may also be requested from the network side, which is not limited here. The manner in which the physical location of the terminal device is determined may be determined according to a GPS module, of course, may also be determined according to the cell in which the terminal device is located, or the terminal device determines the location information according to measurement by virtue of a positioning reference signal, which is not exhaustively listed.

The TA value information between the terminal device and the network device may include at least one of the following: a TA value of the source network device, a TA offset value with the source network device, a TA offset value with the target network device, a TA value with the target network device, a TA adjusting factor with the target network device, or a TA adjusting factor with the source network device.

After receiving the synchronization indication information, the network device may perform at least one of the following:

determining the signal measurement difference based on a signal measurement value of the terminal device at the source network device and a signal measurement value of the terminal at the target network device; thus determining the difference between the TA of the terminal device at the source network device and the TA of the terminal device at the target network device;

determining the difference of TA directly based on the difference between the distance between the terminal device and the source network device and the distance between the terminal device and the target network device;

determining the TA values of the source network device and the target network device by combining the TA value of the source network device with the TA adjusting factor of the target network device;

determining the TA values of the source network device and the target network device by combing the TA value of the source network device with the TA adjusting factor of the target network device, thus determining the difference of TA;

determining the TA values of the source network device and the target network device by combining the TA value of the target network device with the TA adjusting factor of the source network device;

determining the TA values of the source network device and the target network device by combining the TA value of the target network device with the TA adjusting factor of the source network device, thus determining the difference of TA.

Certainly, corresponding to different TA value information, there may be different combination manners being processed to obtain the difference of TA, which will not be exhaustively listed here. It should also be noted that, when there are a plurality of candidate target network devices for the terminal device and a handover procedure is initiated to one of the target network devices, the synchronization indication information needs to include an identifier of the target network device or an identifier of the selected candidate target network device.

For the present embodiment, it may be applied to a plurality of scenarios. It may be any handover scenarios in which the TAs between the terminal device and the source network device/the target network device are different. For example, a handover occurs between network devices, or cells in the network device but at different frequencies, or between other network devices which are not synchronized.

Certainly, it may also be a situation that the terminal device in handover processing can acquire a plurality of candidate target network devices (or candidate target cells). In this case, the plurality of candidate target network devices may be sent to the terminal device by the source network device. The terminal device selects one target network device to initiate the handover processing each time. That is, the target network device in the embodiment may be one of at least one candidate target network device.

It may also be a scenario in which two sets of protocol stacks are maintained. The terminal device retains a first protocol stack and a first related key with the source network device, and maintains a second protocol stack and a second related key with a first target network device; and

the first related key is different from the second related key.

The first protocol stack and the second protocol stack may be the same or different, or at least partially different. For example, when aiming at the 5G system, different Service Data Adaptation Protocols (SDAP), different Packet Data Convergence Protocols (PDCP), different Radio Link Control (RLC) protocols, different Media Access Control (MAC) entities and different Low layer entities may be maintained between the terminal device and the source network device, and between the terminal device and the first target network device. When aiming at a 4G system, different Packet Data Convergence Protocols (PDCP), different Radio Link Control (RLC) protocols, different Media Access Control (MAC) entities and different Low layer entities may be maintained between the terminal device and the source network device, and between the terminal device and the first target network device. In addition, in the solution provided by the embodiment, in order to ensure that different keys are used, the PDCPs of the first protocol stack and the second protocol stack must be different. At least one of the SDAP, the RLC, the MAC or a physical layer may be the same or different. Alternatively, the first protocol stack and the second protocol stack may share at least one of the SDAP, the RLC, the MAC or the physical layer, or may have the SDAP, the RLC, the MAC and the physical layer respectively.

It can clearly be seen that, by adopting the above solution, at least one of the TA value between the terminal device and the source network device, the TA value between the terminal device and the target network device or a difference of TA between the two is acquired according to assistance of the synchronization indication information. Thus, it can be ensured that a synchronization difference with the source network device and a synchronization difference with the target network device are acquired at the handover of the terminal device, and it is not necessary to communicate with a specified network device at a specified time.

### Embodiment 4

An embodiment of the present application provides a synchronization indication method, which is applied to a network device, as shown in FIG. 6, including:

Step 601: sending synchronization indication information to a terminal device;

where the synchronization indication information is configured to assist the terminal device in acquiring at least one of the following:

a timing advance TA value between the terminal device and a source network device; a TA value between the terminal device and the candidate target network device; or a difference between a TA between the terminal device and the source network device and a TA between the terminal device and the target network device.

The synchronization indication information may be carried in an RRC message. In the present embodiment, the synchronization indication information is sent by the source network device to the terminal device, that is, the synchronization indication information may be carried in the RRC message and sent to the terminal device.

The RRC message includes at least a reconfiguration message and a handover command. That is to say, the synchronization indication information may be sent by the network device to the terminal device, and then it may be sent to the terminal device in the RRC message. The RRC message includes but is not limited to the reconfiguration message and the handover command.

In the embodiment, a measurement configuration may also be provided for the terminal device, and of course, the measurement configuration may not be provided for the terminal device. Correspondingly, when the measurement configuration is provided for the terminal device, a measurement is performed based on the measurement configuration; and a measurement result is obtained, and the measurement result is reported to a network side, which may be specifically a source network device side of the network side. Furthermore, the source network device may determine, based on the measurement result, the difference between the TA between the terminal device and the source network device and the TA between the terminal device and the target network device.

The measurement result may include a measurement result for a reference signal of the source network device and a measurement result for a reference signal of at least one target network device.

It should be pointed out that, the RRC message may also be a new RRC message, which may be constituted by introducing a new measurement IE in the RRC message. The IE configures the measurement and is dedicated to the synchronization indication information, and may be specifically configured according to a practical situation. Details are not described herein again.

Regarding the measurement performed by the terminal device on the reference signal, the measurement may be performed on the reference signal sent by the source network device and/or the at least one target network device. For example, the reference signal may include at least one of the following: a cell identifier, a frequency identifier, a measurement ID, an allowed measurement bandwidth, an SSB, a CRS (a specific reference signal of a cell, also referred to as a common reference signal), an MBSFN-RS, a UE-specific RS (a specific reference signal of a mobile station), a PRS, or a CSI-RS, which are not exhaustively listed here.

In addition, the network side may use the new RRC message or RRC reconfiguration information to instruct a UE to report a TA value at a source base station, or the recommended TA value, or a range of the recommended TA value.

On the basis of the above scenario, the synchronization indication information further includes at least one of the following:

a TA value of the terminal device on a target network device side; TA offset values of the terminal device at the source network device and the target network device; or a TA adjusting factor.

The synchronization indication information received by the terminal device from the network device may include the TA value of the terminal device at the target network device. It may be sent to the source network device by the target network device, thus may be sent by the source network device to the terminal device. Regarding the manner for acquiring the TA value by the target network device, reference may be made to the manner described above, which is not described herein again.

In the synchronization indication information, the TA offset value, that is, TA offset, may be an offset time indicated by a TA command. The TA offset value of the target network device may also be sent by the target network device to the source network device, and then the source network device sends the TA offset value of the target network device and a TA value of the source network device together to the terminal device.

The TA adjusting factor may be a value set on a network device side according to an actual situation, and it may include a TA adjusting factor corresponding to the target network device, and/or a TA adjusting factor of the source network device, where the TA adjusting factor corresponding to the target network device may be configured to calculate and obtain the TA value of the target network device based on the TA value of the source network device and the TA adjusting factor of the target network device.

In addition, the TA adjusting factor of the source network device may be configured to calculate and obtain the TA value of the source network device based on the TA value of the target network device and the TA adjusting factor of the source network device.

The TA adjusting factor of the target network device is taken as an example for description. The TA value of the source network device*the TA adjusting factor of the target network device=the TA value of the target network device. It should be understood that, a computing manner for the source network device is similar to that for the target network device, and will not be described herein again.

Correspondingly, the method further includes: sending indication information;

where the indication information includes at least one of the following: a time boundary between the terminal device and the source network device and a time boundary between the terminal device and the target network device; or a difference between a time boundary between the terminal device and the source network device and a time boundary between the terminal device and the target network device.

The present embodiment may be applied to a plurality of scenarios. It may be any handover scenarios in which the TAs between the terminal device and the source network device/the target network device are different. For example, a handover occurs between network devices, or cells in the network device but at different frequencies, or between other network devices which are not synchronized.

Certainly, it may also be a situation that the terminal device in handover processing can acquire a plurality of candidate target network devices (or candidate target cells). In this case, the plurality of candidate target network devices may be sent to the terminal device by the source network device. The terminal device selects one target network device to initiate the handover processing each time. That is, the target network device in the embodiment may be one of at least one candidate target network device.

It may also be a scenario in which two sets of protocol stacks are maintained. The terminal device retains a first protocol stack and a first related key with the source network device, and maintains a second protocol stack and a second related key with a first target network device; and

the first related key is different from the second related key.

The first protocol stack and the second protocol stack may be the same or different, or at least partially different. For example, when aiming at the SG system, different Service Data Adaptation Protocols (SDAP), different Packet Data Convergence Protocols (PDCP), different Radio Link Control (RLC) protocols, different Media Access Control (MAC) entities and different Low layer (Low layer) entities may be maintained between the terminal device and the source network device, and between the terminal device and the first target network device. When aiming at a 4G system, different Packet Data Convergence Protocols (PDCP), different Radio Link Control (RLC) protocols, different Media Access Control (MAC) entities and different Low layer entities may be maintained between the terminal device and the source network device, and between the terminal device and the first target network device. In addition, in the solution provided by the embodiment, in order to ensure that different keys are used, the PDCPs of the first protocol stack and the second protocol stack must be different. At least one of the SDAP, the RLC, the MAC or a physical layer may be the same or different. Alternatively, the first protocol stack and the second protocol stack may share at least one of the SDAP, the RLC, the MAC or the physical layer, or may have the SDAP, the RLC, the MAC and the physical layer respectively.

It can clearly be seen that, by adopting the above solution, at least one of the TA value between the terminal device and the source network device, the TA value between the terminal device and the target network device or a difference of TA between the two is acquired according to assistance of the synchronization indication information. Thus, it can be ensured that a synchronization difference with the source network device and a synchronization difference with the target network device are acquired at the handover of the terminal device, and it is not necessary to communicate with a specified network device at a specified time.

### Embodiment 5

An embodiment of the present application provides a synchronization indication method, which is applied to a network device, including:

sending synchronization indication information to a terminal device;

where the synchronization indication information is configured to configure the terminal device to measure a candidate target network device, so as to assist the network device in acquiring at least one of the following:

a timing advance TA value between the terminal device and a source network device; a TA value between the terminal device and the candidate target network device; or a difference between a TA between the terminal device and the source network device and a TA between the terminal device and the candidate target network device.

The present embodiment differs from the foregoing embodiments in that, in the present embodiment, the network device may configure at least one candidate target network device for the terminal device to perform a measurement. Furthermore, the reporting of the terminal device can be acquired.

In the present embodiment, the network device is assisted to acquire the above information, or may directly acquire the information reported by the terminal device, where the information may include at least one of the following: the timing advance TA value between the terminal device and a source network device; the TA value between the terminal device and the candidate target network device; or the difference between the TA between the terminal device and the source network device and the TA between the terminal device and the candidate target network device.

Certainly, some measurement results reported by the terminal device may also be obtained, and the network device may obtain, according to the assistance of the measurement results, at least one of the following: the timing advance TA value between the terminal device and a source network device; the TA value between the terminal device and the candidate target network device; or the difference between the TA between the terminal device and the source network device and the TA between the terminal device and the candidate target network device.

The synchronization indication information may be carried in an RRC message. The RRC message includes at least a reconfiguration message and a measurement command.

The RRC message includes at least one of the following: an identifier of a candidate target network device; a configuration of a measurement object; or a report configuration.

The amount of the identifier of the candidate target network device may be one or more, that is, the network device notifies the terminal device of the identifiers of all candidate target network devices that need to be measured, which may be at least part of network devices in all network devices that can be measured by the terminal device.

The configuration of the measurement object may include configuration of the terminal device to perform an RSRP measurement, a distance difference measurement, a path loss measurement, and the like.

The report configuration may include a format of reporting information, and content of the reporting information.

For the present embodiment, it may be applied to a plurality of scenarios. It may be any handover scenarios in which the TAs between the terminal device and the source network device/the target network device are different. For example, a handover occurs between network devices, or cells in the network device but at different frequencies, or between other network devices which are not synchronized.

Certainly, it may also be a situation that the terminal device in handover processing can acquire a plurality of candidate target network devices (or candidate target cells). In this case, the plurality of candidate target network devices may be sent to the terminal device by the source network device. The terminal device selects one target network device to initiate the handover processing each time. That is, the target network device in the embodiment may be one of at least one candidate target network device.

It should also be noted that, in the present embodiment, after receiving the above information reported by the terminal device, the network device may further select the target network device for the terminal device according to at least one piece of the information; the timing advance TA value between the terminal device and a source network device; the TA value between the terminal device and the candidate target network device; or the difference between the TA between the terminal device and the source network device and the TA between the terminal device and the candidate target network device. Then the handover processing procedure is executed, which is not described herein again.

It can clearly be seen that, by adopting the above solution, at least one of the TA value between the terminal device and the source network device, the TA value between the terminal device and the target network device or a difference of TA between the two is acquired according to assistance of the synchronization indication information. Thus, it can be ensured that a synchronization difference with the source network device and a synchronization difference with the target network device are acquired at the handover of the terminal device, and it is not necessary to communicate with a specified network device at a specified time.

### Embodiment 6

An embodiment of the present application provides a synchronization indication method, which is applied to a terminal device, including:

receiving synchronization indication information sent by a network device;

where the synchronization indication information is configured to configure the terminal device to measure a candidate target network device, so as to assist the network device in acquiring at least one of the following:

a timing advance TA value between the terminal device and a source network device; a TA value between the terminal device and the candidate target network device; or a difference between a TA between the terminal device and the source network device and a TA between the terminal device and the candidate target network device.

The present embodiment differs from the foregoing embodiments in that, in the present embodiment, the network device may configure at least one candidate target network device for the terminal device to perform a measurement. Furthermore, the reporting of the terminal device can be acquired.

In the present embodiment, the network device is assisted to acquire the above information, or may directly acquire the information reported by the terminal device, where the information may include at least one of the following: the timing advance TA value between the terminal device and a source network device; the TA value between the terminal device and the candidate target network device; or the difference between the TA between the terminal device and the source network device and the TA between the terminal device and the candidate target network device.

Certainly, some measurement results reported by the terminal device may also be obtained, and the network device may obtain, according to the assistance of the measurement results, at least one of the following: the timing advance TA value between the terminal device and a source network device; the TA value between the terminal device and the candidate target network device; or the difference between the TA between the terminal device and the source network device and the TA between the terminal device and the candidate target network device.

The synchronization indication information may be carried in an RRC message. The RRC message includes at least a reconfiguration message and a measurement command.

The RRC message includes at least one of the following: an identifier of a candidate target network device; a configuration of a measurement object; or a report configuration.

The amount of the identifier of the candidate target network device may be one or more, that is, the network device notifies the terminal device of the identifiers of all candidate target network devices that need to be measured, which may be at least part of network devices in all network devices that can be measured by the terminal device.

The configuration of the measurement object may include configuration of the terminal device to perform an RSRP measurement, a distance difference measurement, a path loss measurement, and the like.

The report configuration may include a format of reporting information, and content of the reporting information.

For the present embodiment, it may be applied to a plurality of scenarios. It may be any handover scenarios in which the TAs between the terminal device and the source network device/the target network device are different. For example, a handover occurs between network devices, or cells in the network device but at different frequencies, or between other network devices which are not synchronized.

Certainly, it may also be a situation that the terminal device in handover processing can acquire a plurality of candidate target network devices (or candidate target cells). In this case, the plurality of candidate target network devices may be sent to the terminal device by the source network device. The terminal device selects one target network device to initiate the handover processing each time. That is, the target network device in the embodiment may be one of at least one candidate target network device.

It should also be noted that, in the present embodiment, after the receiving synchronization indication information sent by a network device, the method further includes:

measuring the candidate target network device based on the synchronization indication information to obtain a measurement result; and

determining, based on the measurement result, at least one of the following:

the timing advance TA value between the terminal device and a source network device; the TA value between the terminal device and the candidate target network device; and the difference between the TA between the terminal device and the source network device and the TA between the terminal device and the candidate target network device.

For example, it may be that a measurement is performed on the candidate target network device configured by the terminal device according to the identifier of the candidate target network device in the synchronization indication information, and at least one of an RSRP, a path loss difference, or a distance difference is obtained, so as to determine at least one of the timing advance TA value between the terminal device and a source network device; the TA value between the terminal device and the candidate target network device; or the difference between the TA between the terminal device and the source network device and the TA between the terminal device and the candidate target network device.

Correspondingly, after receiving the information reported by the terminal device, the network device may further select the target network device for the terminal device according to at least one of the timing advance TA value between the terminal device and a source network device; the TA value between the terminal device and the candidate target network device; or the difference between the TA between the terminal device and the source network device and the TA between the terminal device and the candidate target network device. Thus the handover processing flow shown in FIG. 3 is executed, which is not described herein again.

Further, the foregoing manner in which at least one of the timing advance TA value between the terminal device and a source network device; the TA value between the terminal device and the candidate target network device; and the difference between the TA between the terminal device and the source network device and the TA between the terminal device and the candidate target network device is determined may be as follows:

the TA value with the source network device is obtained according to the RSRP corresponding to the source network device, and the candidate target network device adopts the same processing method, which is not described herein again; on this basis, the difference of TA can be further calculated; or

at least one difference between a distance between the terminal device and the source network device and a distance between the terminal device and at least one candidate target network device is calculated according to the distance between the terminal device and the source network device and the distance between the terminal device and the at least one candidate target network device; and at least one difference of TA is estimated based on at least one distance difference.

It should be understood that, the foregoing are merely illustrative descriptions for determining the TA values or the difference of TA, and actually there may be other processing manners, but are not exhaustively listed here.

It can clearly be seen that, by adopting the above solution, at least one of the TA value between the terminal device and the source network device, the TA value between the terminal device and the target network device or a difference of TA between the two is acquired according to assistance of the synchronization indication information. Thus, it can be ensured that a synchronization difference with the source network device and a synchronization difference with the target network device are acquired at the handover of the terminal device, and it is not necessary to communicate with a specified network device at a specified time.

### Embodiment 7

An embodiment of the present application provides a terminal device, as shown in FIG. 7, including:

a first communicating unit 71, configured to receive synchronization indication information sent by a source network device;

where the synchronization indication information is configured to assist the terminal device in acquiring at least one of the following:

a timing advance TA value between the terminal device and a source network device; a TA value between the terminal device and a target network device; or a difference between a TA between the terminal device and the source network device and a TA between the terminal device and the target network device.

Regarding the synchronization indication information received by the terminal device, it may be carried in an RRC message. In the present embodiment, the synchronization indication information is sent by the source network device to the terminal device, that is, the synchronization indication information may be carried in the RRC message and sent to the terminal device.

The RRC message includes at least a reconfiguration message and a handover command. That is to say, the synchronization indication information may be sent by the network device to the terminal device, and then it may be sent to the terminal device in the RRC message, i.e. in the reconfiguration message and the handover command.

In the present embodiment, a measurement configuration may also be provided for the terminal device, and of course, the measurement configuration may not be provided for the terminal device. Correspondingly, when the measurement configuration is provided for the terminal device, the method further includes: performing a measurement based on the measurement configuration; and obtaining a measurement result, and reporting the measurement result to a network side, which may be specifically a source network device side of the network side. Furthermore, the source network device may determine, based on the measurement result, the difference between the TA between the terminal device and the source network device and the TA between the terminal device and the target network device.

The measurement result may include a measurement result for a reference signal of the source network device and a measurement result for a reference signal of at least one target network device.

It should be pointed out that, the RRC message may also be a new RRC message, which may be constituted by introducing a new measurement IE in the RRC message. The IE configures the measurement and is dedicated to the synchronization indication information, and may be specifically configured according to a practical situation. Details are not described herein again.

Regarding the measurement performed by the terminal device on the reference signal, the measurement may be performed on the reference signal sent by the source network device and/or the at least one target network device. For example, the reference signal may include at least one of the following: a cell identifier, a frequency identifier, a measurement ID, an allowed measurement bandwidth, an SSB, a CRS (a specific reference signal of a cell, also referred to as a common reference signal), an MBSFN-RS, a UE-specific RS (a specific reference signal of a mobile station), a PRS, or a CSI-RS, which are not exhaustively listed here.

In addition, the network side may use the new RRC message or RRC reconfiguration information to instruct a UE to report a TA value at a source base station, or the recommended TA value, or a range of the recommended TA value.

On the basis of the above scenario, the synchronization indication information further includes at least one of the following:

a TA value of the terminal device on a target network device side; TA offset values of the terminal device at the source network device and the target network device; or a TA adjusting factor.

The synchronization indication information received by the terminal device from the network device may include the TA value of the terminal device at the target network device. It may be sent to the source network device by the target network device, thus may be sent by the source network device to the terminal device. Regarding the manner for acquiring the TA value by the target network device, reference may be made to the manner described above, which is not described herein again.

In the synchronization indication information, the TA offset value, that is, TA offset, may be an offset time indicated by a TA command. The TA offset value of the target network device may also be sent by the target network device to the source network device, and then the source network device sends the TA offset value of the target network device and a TA value of the source network device together to the terminal device.

The TA adjusting factor may be a value set on a network device side according to an actual situation, and it may include a TA adjusting factor corresponding to the target network device, and/or a TA adjusting factor of the source network device, where the TA adjusting factor corresponding to the target network device may be configured to calculate and obtain the TA value of the target network device based on the TA value of the source network device and the TA adjusting factor of the target network device.

In addition, the TA adjusting factor of the source network device may be configured to calculate and obtain the TA value of the source network device based on the TA value of the target network device and the TA adjusting factor of the source network device.

The TA adjusting factor of the target network device is taken as an example for description. The TA value of the source network device*the TA adjusting factor of the target network device=the TA value of the target network device. It should be understood that, a computing manner for the source network device is similar to that for the target network device, and will not be described herein again.

The first communicating unit 71 is configured to receive indication information sent by the source network device;

where the indication information includes at least one of the following: a time boundary between the terminal device and the source network device and a time boundary between the terminal device and the target network device; or a difference between a time boundary between the terminal device and the source network device and a time boundary between the terminal device and the target network device.

Correspondingly, after the receiving indication information sent by the source network device, the terminal device further includes:

a first processing unit 72, configured to determine, based on the indication information and/or the synchronization indication information, at least one of the following:

the timing advance TA value between the terminal device and the source network device; the TA value between the terminal device and the target network device; or the difference between the TA between the terminal device and the source network device and the TA between the terminal device and the target network device.

Specifically, the TA value between the terminal device and the target network device may be determined based on the indication information and/or the synchronization indication information.

On the basis, based on the TA value between the terminal device and the source network device and the TA value between the terminal device and the target network device, the difference between the TA between the terminal device and the source network device and the TA between the terminal device and the target network device may also be determined.

Further, when a difference of TA is determined, a manner may be adopted by using the indication information. For example, based on a difference value of the time boundary between the terminal device and the source network device and the time boundary between the terminal device and the target network device, the difference between the TA between the terminal device and the source network device and the TA between the terminal device and the target network device may be estimated, where the time boundary between the terminal device and the network device may be understood as a starting point of a radio frame.

For another example, the difference between the TA between the terminal device and the source network device and the TA between the terminal device and the target network device may be determined based on the difference between the time boundary between the terminal device and the source network device and the time boundary between the terminal device and the target network device.

The manner may be mainly applied to downlink synchronization.

Alternatively, another manner may be that the difference of TA is determined directly according to the synchronization indication information. For example, it may include at least one of the following:

acquiring the TA value of the terminal device at the target network device, and based on a self-detected TA value between the terminal device and the source network device, then calculating to obtain a difference of TA between the two;

calculating, according to the TA offset value of the terminal device at the source network device and the TA offset value of the terminal device at the target network device, a difference between the two, which is taken as the difference of TA; or

calculating to obtain the TA value of the target network device based on the TA adjusting factor corresponding to the target network device, and determining the difference of TA between the two in combination with the TA of the target network device and the TA value of the source network device; and/or, determining the TA value of the source network device based on the TA adjusting factor of the source network device, and determining the difference of TA between the two in combination with the TA value of the source network device and the TA value of the target network device.

In another manner, the difference of TA is determined in combination with the synchronization indication information and the indication information, and the foregoing two processing manners may be used in combination. For example, the manner may include:

based on the time boundary between the terminal device and the source network device and the time boundary between the terminal device and the target network device, in combination with the TA value of the terminal device at the target network device in the synchronization indication information, and then according to the self-detected TA value between the terminal device and the source network device, calculating to obtain the difference of TA between the two.

Alternatively, based on the difference between the time boundary between the terminal device and the source network device and the time boundary between the terminal device and the target network device, in combination with the TA adjusting factor corresponding to the target network device, calculating to obtain the TA value of the target network device, then in combination with the TA of the target network device and the TA value of the source network device, determining the difference of TA between the two; and/or determining the TA value of the source network device based on the TA adjusting factor of the source network device, and determining the difference of TA between the two in combination with the TA value of the source network device and the TA value of the target network device.

Certainly, there may be other combination manners, which are not exhaustively listed here. Furthermore, it can also be understood that, after the aforementioned TA values are determined, the difference of TA may be further determined, or merely the TA values are acquired without calculating the difference of TA. It may be set in a specific implementation according to an actual situation, which is not limited in the present embodiment.

In addition, it should be noted that, the timing advance (TA, timing advance) may be used for uplink transmission, which means that in order to make an uplink packet arrive at the network device at a desired time, a radio frequency transmission delay caused by a distance is estimated and a data packet is sent in advance at a corresponding time. In order to ensure time synchronization on the network device side, the LTE proposes a mechanism of Uplink Timing Advance. From the perspective of the terminal device side, the TA is essentially a negative offset between a start moment for receiving a downlink sub-frame and a moment for transmitting an uplink sub-frame. By appropriately controlling an offset of each terminal device, the network device can control the time when uplink signals from different terminal devices reach the network device. For a terminal device remote from the network device, since there is a large transmission delay, uplink data is sent earlier than a terminal device close to the network device. Regarding how to acquire the TA in the uplink transmission, the TA value of each terminal device may be determined by the network device through measuring the uplink transmission of the terminal device. It can be understood that, as long as the terminal device has the uplink transmission, the network device may be configured to estimate the TA value.

The present embodiment may be applied to a plurality of scenarios. It may be any handover scenarios in which the TAs between the terminal device and the source network device the target network device are different. For example, a handover occurs between network devices, or cells in the network device but at different frequencies, or between other network devices which are not synchronized.

Certainly, it may also be a situation that the terminal device in handover processing can acquire a plurality of candidate target network devices (or candidate target cells). In this case, the plurality of candidate target network devices may be sent to the terminal device by the source network device. The terminal device selects one target network device to initiate the handover processing each time. That is, the target network device in the embodiment may be one of at least one candidate target network device.

It may also be a scenario in which two sets of protocol stacks are maintained. The terminal device retains a first protocol stack and a first related key with the source network device, and maintains a second protocol stack and a second related key with a first target network device; and

the first related key is different from the second related key.

The first protocol stack and the second protocol stack may be the same or different, or at least partially different. For example, when aiming at the 5G system, different Service Data Adaptation Protocols (SDAP), different Packet Data Convergence Protocols (PDCP), different Radio Link Control (RLC) protocols, different Media Access Control (MAC) entities and different Low layer entities may be maintained between the terminal device and the source network device, and between the terminal device and the first target network device. When aiming at a 4G system, different Packet Data Convergence Protocols (PDCP), different Radio Link Control (RLC) protocols, different Media Access Control (MAC) entities and different Low layer entities may be maintained between the terminal device and the source network device, and between the terminal device and the first target network device. In addition, in the solution provided by the embodiment, in order to ensure that different keys are used, the PDCPs of the first protocol stack and the second protocol stack must be different. At least one of the SDAP, the RLC, the MAC or a physical layer may be the same or different. Alternatively, the first protocol stack and the second protocol stack may share at least one of the SDAP, the RLC, the MAC or the physical layer, or may have the SDAP, the RLC, the MAC and the physical layer respectively.

It can clearly be seen that, by adopting the above solution, at least one of the TA value between the terminal device and the source network device, the TA value between the terminal device and the target network device or the difference of TA between the two is acquired according to assistance of the synchronization indication information. Thus, it can be ensured that a synchronization difference with the source network device and a synchronization difference with the target network device are acquired at the handover of the terminal device, and it is not necessary to communicate with a specified network device at a specified time.

### Embodiment 8

An embodiment of the present application provides a terminal device, including:

a second communicating unit, configured to send synchronization indication information to a network device;

where the synchronization indication information is configured to assist the network device in acquiring at least one of the following:

a timing advance TA value between the terminal device and a source network device; a TA value between the terminal device and a target network device; or a difference between a TA between the terminal device and the source network device and a TA between the terminal device and the target network device.

It should be noted that, in the present embodiment, the network device may be the source network device or the target network device. In other words, the terminal device may send the synchronization indication information to the source network device, or may send the synchronization indication information to the target network device.

Regarding the synchronization indication information, it may be carried in an RRC message, where the RRC message includes at least a measurement report message.

It should be understood that, when the measurement report message is included in the synchronization indication information, a measurement configuration sent by the source network device or the target network device on a network side may be received. A measurement is performed based on the measurement configuration; and a measurement result is obtained, and the measurement result is reported to the network side.

Correspondingly, the source network device or the target network device may determine the difference between the TA between the terminal device and the source network device and the TA between the terminal device and the target network device according to the measurement result.

The measurement result may include a measurement result for a reference signal of the source network device and a measurement result for a reference signal of at least one target network device.

Regarding the measurement performed by the terminal device on the reference signal, the measurement may be performed on the reference signal sent by the source network device and/or the at least one target network device. For example, the reference signal may include at least one of the following: a cell identifier, a frequency identifier, a measurement ID, an allowed measurement bandwidth, an SSB, a CRS (a specific reference signal of a cell, also referred to as a common reference signal), an MBSFN-RS, a UE-specific RS (a specific reference signal of a mobile station), a PRS, or a CSI-RS, which are not exhaustively listed here.

In addition, it should be noted that, the timing advance (TA) may be used for uplink transmission.

On the basis of the above scenario, the synchronization indication information further includes at least one of the following: a signal measurement difference of the terminal device at the source network device and the target network device; a difference between a distance between the terminal device and the source network device and a distance between the terminal device and the target network device; a difference between a path loss between the terminal device and the source network device and a path loss between the terminal device and the target network device; TA value information between the terminal device and the network device; an identifier of the target network device; or an identifier of a candidate target network device selected by the terminal device.

In addition, the synchronization indication information may further include a candidate target cell list in addition to the above information. The candidate target cell list includes but is not limited to at least one of the following: a cell ID, a measurement result (such as RSRP), positioning information, or path loss information.

Specifically, the synchronization indication information includes a measurement difference (such as RSRP) of the terminal device at the source network device and the target network device, or a distance difference (such as acquired according to a positioning reference signal) of the terminal device at the source network device and the target network device, or recommended TA value information, such as a TA value with a source cell, or various combinations thereof.

The terminal device may measure to obtain a signal measurement result of the source network device, and obtain a signal measurement result of the target network device, and determine the signal measurement difference of the terminal device at the source network device and the target network device based on the two results.

Regarding the difference of the distance between the terminal device and the source network device and the distance between the terminal device and the target network device, it may be determined based on physical locations of the source network device and the target network device and a physical location of the terminal device. The manner in which the physical location of the network device is acquired may be preconfigured by the network side, or may also be requested from the network side, which is not limited here. The manner in which the physical location of the terminal device is determined may be determined according to a GPS module, of course, may also be determined according to the cell in which the terminal device is located, or the terminal device determines the location information according to measurement by virtue of a positioning reference signal, which is not exhaustively listed.

The TA value information between the terminal device and the network device may include at least one of the following: a TA value of the source network device, a TA offset value with the source network device, a TA offset value with the target network device, a TA value with the target network device, a TA adjusting factor with the target network device, or a TA adjusting factor with the source network device.

In addition, when the terminal device pre-acquires related information of at least one candidate target network device configured by the network side, the terminal device may directly notify the network side of identification information of the currently selected target network device when the handover fails or the handover is performed. In this case, it may be an identifier of the target network device selected by the terminal device for handover. Of course, several candidate target network devices with better communication quality may also be selected by the terminal device, and identifiers of the candidate target network devices are sent to the source network device, and the source network device selects the target network device for the terminal device. A better communication quality may be determined according to the measurement result of the reference signal, for example, a signal-to-noise ratio that is greater than a preset signal-to-noise ratio threshold, or top N (N is greater than or equal to 1 and less than or equal to the amount of all candidate network devices) in the sorted signal-to-noise ratios may be included. Of course, other parameters may also be used for measuring the communication quality. For example, other parameters may include a signal strength and a noise strength, and they may also be used in combination, which will not be exhaustively listed here, and it should be understood that, the selection manner is similar to the foregoing selection manner based on the signal-to-noise ratio, which will not be described herein again.

For the present embodiment, it may be applied to a plurality of scenarios. It may be any handover scenarios in which the TAs between the terminal device and the source network device/the target network device are different. For example, a handover occurs between network devices, or cells in the network device but at different frequencies, or between other network devices which are not synchronized.

Certainly, it may also be a situation that the terminal device in handover processing can acquire a plurality of candidate target network devices (or candidate target cells). In this case, the plurality of candidate target network devices may be sent to the terminal device by the source network device. The terminal device selects one target network device to initiate the handover processing each time. That is, the target network device in the embodiment may be one of at least one candidate target network device.

It may also be a scenario in which two sets of protocol stacks are maintained. The terminal device retains a first protocol stack and a first related key with the source network device, and maintains a second protocol stack and a second related key with a first target network device; and the first related key is different from the second related key.

The first protocol stack and the second protocol stack may be the same or different, or at least partially different. For example, when aiming at the 5G system, different Service Data Adaptation Protocols (SDAP), different Packet Data Convergence Protocols (PDCP), different Radio Link Control (RLC) protocols, different Media Access Control (MAC) entities and different Low layer entities may be maintained between the terminal device and the source network device, and between the terminal device and the first target network device. When aiming at a 4G system, different Packet Data Convergence Protocols (PDCP), different Radio Link Control (RLC) protocols, different Media Access Control (MAC) entities and different Low layer entities may be maintained between the terminal device and the source network device, and between the terminal device and the first target network device. In addition, in the solution provided by the embodiment, in order to ensure that different keys are used, the PDCPs of the first protocol stack and the second protocol stack must be different. At least one of the SDAP, the RLC, the MAC or a physical layer may be the same or different. Alternatively, the first protocol stack and the second protocol stack may share at least one of the SDAP, the RLC, the MAC or the physical layer, or may have the SDAP, the RLC, the MAC and the physical layer respectively.

It can clearly be seen that, by adopting the above solution, at least one of the TA value between the terminal device and the source network device, the TA value between the terminal device and the target network device or a difference of TA between the two is acquired according to assistance of the synchronization indication information. Thus, it can be ensured that a synchronization difference with the source network device and a synchronization difference with the target network device are acquired at the handover of the terminal device, and it is not necessary to communicate with a specified network device at a specified time.

### Embodiment 9

An embodiment of the present application provides a network device, including:

a third communicating unit, configured to receive synchronization indication information sent by a terminal device:

where the synchronization indication information is configured to assist the network device in acquiring at least one of the following:

a timing advance TA value between the terminal device and a source network device; a TA value between the terminal device and a target network device; or a difference between a TA between the terminal device and the source network device and a TA between the terminal device and the target network device.

Further, the present embodiment may further include: acquiring, based on the synchronization indication information, the difference between a timing advance (TA) between the terminal device and the source network device and the TA between the terminal device and the target network device.

It should be noted that, in the present embodiment, the network device may be the source network device or the target network device. In other words, the terminal device may send the synchronization indication information to the source network device, or may send the synchronization indication information to the target network device.

Regarding the synchronization indication information, it may be carried in an RRC message, where the RRC message includes at least a measurement report message.

It should be understood that, when the measurement report message is included in the synchronization indication information, a measurement configuration sent by the source network device or the target network device on a network side may be received. A measurement is performed based on the measurement configuration; and a measurement result is obtained, and the measurement result is reported to the network side.

Correspondingly, the network device, such as the source network device or the target network device, may determine the difference between the TA between the terminal device and the source network device and the TA between the terminal device and the target network device according to the measurement result in the measurement report message.

The measurement result may include a measurement result for a reference signal of the source network device and a measurement result for a reference signal of at least one target network device.

Regarding the measurement performed by the terminal device on the reference signal, the measurement may be performed on the reference signal sent by the source network device and/or the at least one target network device. For example, the reference signal may include at least one of the following: a cell identifier, a frequency identifier, a measurement ID, an allowed measurement bandwidth, an SSB, a CRS (a specific reference signal of a cell, also referred to as a common reference signal), an MBSFN-RS, a UE-specific RS (a specific reference signal of a mobile station), a PRS, or a CS-RS, which are not exhaustively listed here.

On the basis of the above scenario, the synchronization indication information further includes at least one of the following: a signal measurement difference of the terminal device at the source network device and the target network device; a difference between a distance between the terminal device and the source network device and a distance between the terminal device and the target network device; a difference between a path loss between the terminal device and the source network device and a path loss between the terminal device and the target network device; TA value information between the terminal device and the network device; an identifier of the target network device; or an identifier of a candidate target network device selected by the terminal device.

In addition, the synchronization indication information may further include a candidate target cell list in addition to the above information. The candidate target cell list includes but is not limited to at least one of the following: a cell ID, a measurement result (such as RSRP), location information, and path loss information.

Specifically, the synchronization indication information includes a measurement difference (such as RSRP) of the terminal device at the source network device and the target network device, or a distance difference (such as acquired according to a positioning reference signal) of the terminal device at the source network device and the target network device, or recommended TA value information, such as a TA value with a source cell, or various combinations thereof.

The terminal device may measure to obtain a signal measurement result of the source network device, and obtain a signal measurement result of the target network device, and determine the signal measurement difference of the terminal device at the source network device and the target network device based on the two results.

Regarding the difference of the distance between the terminal device and the source network device and the distance between the terminal device and the target network device, it may be determined based on physical locations of the source network device and the target network device and a physical location of the terminal device. The manner in which the physical location of the network device is acquired may be preconfigured by the network side, or may also be requested from the network side, which is not limited here. The manner in which the physical location of the terminal device is determined may be determined according to a GPS module, of course, may also be determined according to the cell in which the terminal device is located, or the terminal device determines the location information according to measurement by virtue of a positioning reference signal, which is not exhaustively listed.

The TA value information between the terminal device and the network device may include at least one of the following: a TA value of the source network device, a TA offset value with the source network device, a TA offset value with the target network device, a TA value with the target network device, a TA adjusting factor with the target network device, or a TA adjusting factor with the source network device.

After receiving the synchronization indication information, the network device may perform at least one of the following:

determining the signal measurement difference based on a signal measurement value of the terminal device at the source network device and a signal measurement value of the terminal at the target network device; thus determining the difference between the TA of the terminal device at the source network device and the TA of the terminal device at the target network device;

determining the difference of TA directly based on the difference between the distance between the terminal device and the source network device and the distance between the terminal device and the target network device;

determining the TA values of the source network device and the target network device by combining the TA value of the source network device with the TA adjusting factor of the target network device;

determining the TA values of the source network device and the target network device by combing the TA value of the source network device with the TA adjusting factor of the target network device, thus determining the difference of TA;

determining the TA values of the source network device and the target network device by combining the TA value of the target network device with the TA adjusting factor of the source network device;

determining the TA values of the source network device and the target network device by combining the TA value of the target network device with the TA adjusting factor of the source network device, thus determining the difference of TA.

Certainly, corresponding to different TA value information, there may be different combination manners being processed to obtain the difference of TA, which will not be exhaustively listed here. It should also be noted that, when there are a plurality of candidate target network devices for the terminal device and a handover procedure is initiated to one of the target network devices, the synchronization indication information needs to include an identifier of the target network device or an identifier of the selected candidate target network device.

For the present embodiment, it may be applied to a plurality of scenarios. It may be any handover scenarios in which the TAs between the terminal device and the source network device/the target network device are different. For example, a handover occurs between network devices, or cells in the network device but at different frequencies, or between other network devices which are not synchronized.

Certainly, it may also be a situation that the terminal device in handover processing can acquire a plurality of candidate target network devices (or candidate target cells). In this case, the plurality of candidate target network devices may be sent to the terminal device by the source network device. The terminal device selects one target network device to initiate the handover processing each time. That is, the target network device in the embodiment may be one of at least one candidate target network device.

It may also be a scenario in which two sets of protocol stacks are maintained. The terminal device retains a first protocol stack and a first related key with the source network device, and maintains a second protocol stack and a second related key with a first target network device, and the first related key is different from the second related key.

The first protocol stack and the second protocol stack may be the same or different, or at least partially different. For example, when aiming at the SG system, different Service Data Adaptation Protocols (SDAP), different Packet Data Convergence Protocols (PDCP), different Radio Link Control (RLC) protocols, different Media Access Control (MAC) entities and different Low layer entities may be maintained between the terminal device and the source network device, and between the terminal device and the first target network device. When aiming at a 4G system, different Packet Data Convergence Protocols (PDCP), different Radio Link Control (RLC) protocols, different Media Access Control (MAC) entities and different Low layer entities may be maintained between the terminal device and the source network device, and between the terminal device and the first target network device. In addition, in the solution provided by the embodiment, in order to ensure that different keys are used, the PDCPs of the first protocol stack and the second protocol stack must be different. At least one of the SDAP, the RLC, the MAC or a physical layer may be the same or different. Alternatively, the first protocol stack and the second protocol stack may share at least one of the SDAP, the RLC, the MAC or the physical layer, or may have the SDAP, the RLC, the MAC and the physical layer respectively.

It can clearly be seen that, by adopting the above solution, at least one of the TA value between the terminal device and the source network device, the TA value between the terminal device and the target network device or a difference of TA between the two is acquired according to assistance of the synchronization indication information. Thus, it can be ensured that a synchronization difference with the source network device and a synchronization difference with the target network device are acquired at the handover of the terminal device, and it is not necessary to communicate with a specified network device at a specified time.

### Embodiment 10

An embodiment of the present application provides a network device, including:

a fourth communicating unit, configured to send synchronization indication information to a terminal device:

where the synchronization indication information is configured to assist the terminal device in acquiring at least one of the following:

a timing advance TA value between the terminal device and a source network device; a TA value between the terminal device and a target network device; or a difference between a TA between the terminal device and the source network device and a TA between the terminal device and the target network device.

The synchronization indication information may be carried in an RRC message. In the present embodiment, the synchronization indication information is sent by the source network device to the terminal device, that is, the synchronization indication information may be carried in the RRC message and sent to the terminal device.

The RRC message includes at least a reconfiguration message and a handover command. That is to say, the synchronization indication information may be sent by the network device to the terminal device, and then it may be sent to the terminal device in the RRC message. The RRC message includes but is not limited to the reconfiguration message and the handover command.

In the embodiment, a measurement configuration may also be provided for the terminal device, and of course, the measurement configuration may not be provided for the terminal device. Correspondingly, when the measurement configuration is provided for the terminal device, a measurement is performed based on the measurement configuration; and a measurement result is obtained, and the measurement result is reported to a network side, which may be specifically a source network device side of the network side. Furthermore, the source network device may determine, based on the measurement result, the difference between the TA between the terminal device and the source network device and the TA between the terminal device and the target network device.

The measurement result may include a measurement result for a reference signal of the source network device and a measurement result for a reference signal of at least one target network device.

It should be pointed out that, the RRC message may also be a new RRC message, which may be constituted by introducing a new measurement JE in the RRC message. The IE configures the measurement and is dedicated to the synchronization indication information, and may be specifically configured according to a practical situation. Details are not described herein again.

Regarding the measurement performed by the terminal device on the reference signal, the measurement may be performed on the reference signal sent by the source network device and/or the at least one target network device. For example, the reference signal may include at least one of the following: a cell identifier, a frequency identifier, a measurement ID, an allowed measurement bandwidth, an SSB, a CRS (a specific reference signal of a cell, also referred to as a common reference signal), an MBSFN-RS, a UE-specific RS (a specific reference signal of a mobile station), a PRS, or a CSI-RS, which are not exhaustively listed here.

In addition, the fourth communicating unit may use the new RRC message or RRC reconfiguration information to instruct a UE to report a TA value at a source base station, or the recommended TA value, or a range of the recommended TA value.

On the basis of the above scenario, the synchronization indication information further includes at least one of the following:

a TA value of the terminal device on a target network device side; TA offset values of the terminal device at the source network device and the target network device; or a TA adjusting factor.

The synchronization indication information received by the terminal device from the network device may include the TA value of the terminal device at the target network device. It may be sent to the source network device by the target network device, thus may be sent by the source network device to the terminal device. Regarding the manner for acquiring the TA value by the target network device, reference may be made to the manner described above, which is not described herein again.

In the synchronization indication information, the TA offset value, that is, TA offset, may be an offset time indicated by a TA command. The TA offset value of the target network device may also be sent by the target network device to the source network device, and then the source network device sends the TA offset value of the target network device and a TA value of the source network device together to the terminal device.

The TA adjusting factor may be a value set on a network device side according to an actual situation, and it may include a TA adjusting factor corresponding to the target network device, and/or a TA adjusting factor of the source network device, where the TA adjusting factor corresponding to the target network device may be configured to calculate and obtain the TA value of the target network device based on the TA value of the source network device and the TA adjusting factor of the target network device.

In addition, the TA adjusting factor of the source network device may be configured to calculate and obtain the TA value of the source network device based on the TA value of the target network device and the TA adjusting factor of the source network device.

The TA adjusting factor of the target network device is taken as an example for description. The TA value of the source network device*the TA adjusting factor of the target network device=the TA value of the target network device. It should be understood that, a computing manner for the source network device is similar to that for the target network device, and will not be described herein again.

Correspondingly, the device is further configured to send indication information:

where the indication information includes at least one of the following: a time boundary between the terminal device and the source network device and a time boundary between the terminal device and the target network device; or a difference between a time boundary between the terminal device and the source network device and a time boundary between the terminal device and the target network device.

The present embodiment may be applied to a plurality of scenarios. It may be any handover scenarios in which the TAs between the terminal device and the source network device/the target network device are different. For example, a handover occurs between network devices, or cells in the network device but at different frequencies, or between other network devices which are not synchronized.

Certainly, it may also be a situation that the terminal device in handover processing can acquire a plurality of candidate target network devices (or candidate target cells). In this case, the plurality of candidate target network devices may be sent to the terminal device by the source network device. The terminal device selects one target network device to initiate the handover processing each time. That is, the target network device in the embodiment may be one of at least one candidate target network device.

It may also be a scenario in which two sets of protocol stacks are maintained. The terminal device retains a first protocol stack and a first related key with the source network device, and maintains a second protocol stack and a second related key with a first target network device; and

the first related key is different from the second related key.

The first protocol stack and the second protocol stack may be the same or different, or at least partially different. For example, when aiming at the 5G system, different Service Data Adaptation Protocols (SDAP), different Packet Data Convergence Protocols (PDCP), different Radio Link Control (RLC) protocols, different Media Access Control (MAC) entities and different Low layer entities may be maintained between the terminal device and the source network device, and between the terminal device and the first target network device. When aiming at a 4G system, different Packet Data Convergence Protocols (PDCP), different Radio Link Control (RLC) protocols, different Media Access Control (MAC) entities and different Low layer entities may be maintained between the terminal device and the source network device, and between the terminal device and the first target network device. In addition, in the solution provided by the embodiment, in order to ensure that different keys are used, the PDCPs of the first protocol stack and the second protocol stack must be different. At least one of the SDAP the RLC, the MAC or a physical layer may be the same or different. Alternatively, the first protocol stack and the second protocol stack may share at least one of the SDAP, the RLC, the MAC or the physical layer, or may have the SDAP, the RLC, the MAC and the physical layer respectively.

It can clearly be seen that, by adopting the above solution, at least one of the TA value between the terminal device and the source network device, the TA value between the terminal device and the target network device or a difference of TA between the two is acquired according to assistance of the synchronization indication information. Thus, it can be ensured that a synchronization difference with the source network device and a synchronization difference with the target network device are acquired at the handover of the terminal device, and it is not necessary to communicate with a specified network device at a specified time.

### Embodiment 11

An embodiment of the present application provides a network device, including:

a fifth communicating unit, configured to send synchronization indication information to a terminal device;

where the synchronization indication information is configured to configure the terminal device to measure a candidate target network device, so as to assist the network device in acquiring at least one of the following:

a timing advance TA value between the terminal device and a source network device; a TA value between the terminal device and the candidate target network device; or a difference between a TA between the terminal device and the source network device and a TA between the terminal device and the candidate target network device.

The present embodiment differs from the foregoing embodiments in that, in the present embodiment, the network device may configure at least one candidate target network device for the terminal device to perform a measurement. Furthermore, the reporting of the terminal device can be acquired.

In the present embodiment, the network device is assisted to acquire the above information, or may directly acquire the information reported by the terminal device, where the information may include at least one of the following: the timing advance TA value between the terminal device and a source network device; the TA value between the terminal device and the candidate target network device; or the difference between the TA between the terminal device and the source network device and the TA between the terminal device and the candidate target network device.

Certainly, some measurement results reported by the terminal device may also be obtained, and the network device may obtain, according to the assistance of the measurement results, at least one of the following: the timing advance TA value between the terminal device and a source network device; the TA value between the terminal device and the candidate target network device; or the difference between the TA between the terminal device and the source network device and the TA between the terminal device and the candidate target network device.

The synchronization indication information may be carried in an RRC message. The RRC message includes at least a reconfiguration message and a measurement command.

The RRC message includes at least one of the following: an identifier of a candidate target network device; a configuration of a measurement object; or a report configuration.

The amount of the identifier of the candidate target network device may be one or more, that is, the network device notifies the terminal device of the identifiers of all candidate target network devices that need to be measured, which may be at least part of network devices in all network devices that can be measured by the terminal device.

The configuration of the measurement object may include configuration of the terminal device to perform an RSRP measurement, a distance difference measurement, a path loss measurement, and the like.

The report configuration may include a format of reporting information, and content of the reporting information.

For the present embodiment, it may be applied to a plurality of scenarios. It may be any handover scenarios in which the TAs between the terminal device and the source network device/the target network device are different. For example, a handover occurs between network devices, or cells in the network device but at different frequencies, or between other network devices which are not synchronized.

Certainly, it may also be a situation that the terminal device in handover processing can acquire a plurality of candidate target network devices (or candidate target cells). In this case, the plurality of candidate target network devices may be sent to the terminal device by the source network device. The terminal device selects one target network device to initiate the handover processing each time. That is, the target network device in the embodiment may be one of at least one candidate target network device.

It should also be noted that, in the present embodiment, after receiving the above information reported by the terminal device, the network device may further select the target network device for the terminal device according to at least one piece of the information; the timing advance TA value between the terminal device and a source network device; the TA value between the terminal device and the candidate target network device; or the difference between the TA between the terminal device and the source network device and the TA between the terminal device and the candidate target network device. Then the handover processing procedure is executed, which is not described herein again.

It can clearly be seen that, by adopting the above solution, at least one of the TA value between the terminal device and the source network device, the TA value between the terminal device and the target network device or a difference of TA between the two is acquired according to assistance of the synchronization indication information. Thus, it can be ensured that a synchronization difference with the source network device and a synchronization difference with the target network device are acquired at the handover of the terminal device, and it is not necessary to communicate with a specified network device at a specified time.

### Embodiment 12

An embodiment of the present application provides a terminal device, as shown in FIG. 8, including:

a sixth communicating unit 81, configured to receive synchronization indication information sent by a network device;

where the synchronization indication information is configured to configure the terminal device to measure a candidate target network device, so as to assist the network device in acquiring at least one of the following:

a timing advance TA value between the terminal device and a source network device; a TA value between the terminal device and the candidate target network device; or a difference between a TA between the terminal device and the source network device and a TA between the terminal device and the candidate target network device.

The present embodiment differs from the foregoing embodiments in that, in the present embodiment, the network device may configure at least one candidate 6s target network device for the terminal device to perform a measurement. Furthermore, the reporting of the terminal device can be acquired.

In the present embodiment, the network device is assisted to acquire the above information, or may directly acquire the information reported by the terminal device, where the information may include at least one of the following: the timing advance TA value between the terminal device and a source network device; the TA value between the terminal device and the candidate target network device; or the difference between the TA between the terminal device and the source network device and the TA between the terminal device and the candidate target network device.

Certainly, some measurement results reported by the terminal device may also be obtained, and the network device may obtain, according to the assistance of the measurement results, at least one of the following: the timing advance TA value between the terminal device and a source network device; the TA value between the terminal device and the candidate target network device; or the difference between the TA between the terminal device and the source network device and the TA between the terminal device and the candidate target network device.

The synchronization indication information may be carried in an RRC message. The RRC message includes at least a reconfiguration message and a measurement command.

The RRC message includes at least one of the following: an identifier of a candidate target network device; a configuration of a measurement object; or a report configuration.

The amount of the identifier of the candidate target network device may be one or more, that is, the network device notifies the terminal device of the identifiers of all candidate target network devices that need to be measured, which may be at least part of network devices in all network devices that can be measured by the terminal device.

The configuration of the measurement object may include configuration of the terminal device to perform an RSRP measurement, a distance difference measurement, a path loss measurement, and the like.

The report configuration may include a format of reporting information, and content of the reporting information.

For the present embodiment, it may be applied to a plurality of scenarios. It may be any handover scenarios in which the TAs between the terminal device and the source network device/the target network device are different. For example, a handover occurs between network devices, or cells in the network device but at different frequencies, or between other network devices which are not synchronized.

Certainly, it may also be a situation that the terminal device in handover processing can acquire a plurality of candidate target network devices (or candidate target cells). In this case, the plurality of candidate target network devices may be sent to the terminal device by the source network device. The terminal device selects one target network device to initiate the handover processing each time. That is, the target network device in the embodiment may be one of at least one candidate target network device.

It should also be noted that, in the present embodiment, after the receiving synchronization indication information sent by a network device, the terminal device further includes:

a sixth processing unit 82, configured to measure the candidate target network device based on the synchronization indication information to obtain a measurement result; and

determines, based on the measurement result, at least one of the following:

the timing advance TA value between the terminal device and a source network device; the TA value between the terminal device and the candidate target network device; or the difference between the TA between the terminal device and the source network device and the TA between the terminal device and the candidate target network device.

For example, it may be that a measurement is performed on the candidate target network device configured by the terminal device according to the identifier of the candidate target network device in the synchronization indication information, and at least one of an RSRP, a path loss difference, or a distance difference is obtained, so as to determine at least one of the timing advance TA value between the terminal device and a source network device; the TA value between the terminal device and the candidate target network device; or the difference between the TA between the terminal device and the source network device and the TA between the terminal device and the candidate target network device.

Correspondingly, after receiving the information reported by the terminal device, the network device may further select the target network device for the terminal device according to at least one of the timing advance TA value between the terminal device and a source network device; the TA value between the terminal device and the candidate target network device; or the difference between the TA between the terminal device and the source network device and the TA between the terminal device and the candidate target network device. Thus the handover processing flow shown in FIG. 3 is executed, which is not described herein again.

Further, the foregoing manner in which at least one of the timing advance TA value between the terminal device and a source network device; the TA value between the terminal device and the candidate target network device; and the difference between the TA between the terminal device and the source network device and the TA between the terminal device and the candidate target network device is determined may be as follows:

the TA value with the source network device is obtained according to the RSRP corresponding to the source network device, and the candidate target network device adopts the same processing method, which is not described herein again; on this basis, the difference of TA can be further calculated; or

at least one of the difference between a distance between the terminal device and the source network device and a distance between the terminal device and at least one candidate target network device is calculated according to the distance between the terminal device and the source network device and the distance between the terminal device and the at least one candidate target network device; and at least one difference of TA is estimated based on at least one distance difference.

It should be understood that, the foregoing are merely illustrative descriptions for determining the TA values or the difference of TA, and actually there may be other processing manners, but are not exhaustively listed here.

It can clearly be seen that, by adopting the above solution, at least one of the TA value between the terminal device and the source network device, the TA value between the terminal device and the target network device or a difference of TA between the two is acquired according to assistance of the synchronization indication information. Thus, it can be ensured that a synchronization difference with the source network device and a synchronization difference with the target network device are acquired at the handover of the terminal device, and it is not necessary to communicate with a specified network device at a specified time.

FIG. 9 is a schematic structural diagram of a communication device 900 according to an embodiment of the present application, and the communication device may be the foregoing terminal device or network device in the present embodiment. The communication device 900 shown in FIG. 9 includes a processor 910, where the processor 910 may invoke and run a computer program from a memory to implement a method in an embodiment of the present application.

In an embodiment, as shown in FIG. 9, the communication device 900 may further include a memory 920. The processor 910 may invoke and run the computer program from the memory 920 to implement the method in the embodiment of the present application.

The memory 920 may be a separate device which is independent of the processor 910, or may be integrated in the processor 910.

In an embodiment, as shown in FIG. 9, the communication device 900 may further include a transceiver 930, and the processor 910 may communicate with other devices by controlling the transceiver 930. Specifically, information or data may be sent to other devices, or information or data sent by other devices can be received.

The transceiver 930 may include a transmitter and a receiver. The transceiver 930 may further include an antenna, and the amount of the antennas may be one or more.

In an embodiment, the communication device 900 may specifically be a network device in the embodiments of the present application, and the communication device 900 may implement corresponding processes implemented by the network device in various methods in the embodiments of the present application. It is not described herein for simplicity.

In an embodiment, the communication device 90 may specifically be a terminal device or the network device in the embodiments of the present application, and the communication device 900 may implement corresponding processes implemented by the terminal device/a mobile terminal in various methods in the embodiments of the present application. It is not described herein for simplicity.

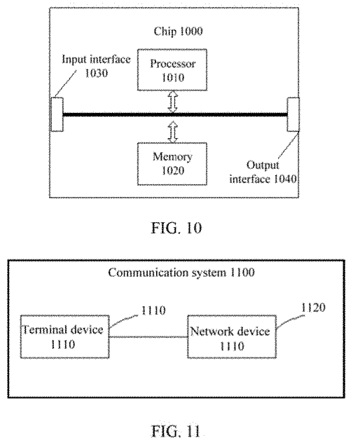

FIG. 10 is a schematic structural diagram of a chip according to an embodiment of the present application. The chip 1000 shown in FIG. 10 includes a processor 1010, where the processor 1010 may invoke and run a computer program from a memory to implement a method in an embodiment of the present application.

In an embodiment, as shown in FIG. 10, the chip 1000 may further include a memory 1020. The processor 1010 may invoke and run the computer program from the memory 1020 to implement the method in the embodiment of the present application, where the memory 1020 may be a separate device which is independent of the processor 1010, or may be integrated in the processor 1010.

In an embodiment, the chip 1000 may further include an input interface 1030. The processor 1010 may communicate with other devices or chips by controlling the input interface 1030. Specifically, information or data sent by other devices or chips may be acquired.

In an embodiment, the chip 1000 may further include an output interface 1040. The processor 1010 may communicate with other devices or chips by controlling the output interface 1040. Specifically, information or data may be output to other devices or chips.

In an embodiment, the chip may be applied to a network device in the embodiments of the present application, and the chip may implement corresponding processes implemented by the network device in various methods in the embodiments of the present application. It is not described herein for simplicity.

In an embodiment, the chip may be applied to a terminal device in the embodiments of the present application, and the chip may implement corresponding processes implemented by the terminal device in various methods in the embodiments of the present application. It is not described herein for simplicity.

It should be understood that, the chip mentioned in the embodiments of the present application may also be referred to as a system on chip, a system chip, a chip system or a system-on-chip chip, etc.

FIG. 11 is a schematic diagram of a communication system 1100 according to an embodiment of the present application. As shown in FIG. 11, the communication system 1100 includes a terminal device 1110 and a network device 1120, where the terminal device 1110 may be configured to implement corresponding functions implemented by the terminal device in the foregoing methods, and the network device 1120 may be configured to implement corresponding functions implemented by the network device in the foregoing methods. It is not described herein for simplicity.

It should be understood that, the processor in the embodiments of the present application may be an integrated circuit chip having a capability of signal processing. In the implementation process, each step of the foregoing method embodiments may be completed by an integrated logic circuit of hardware in the processor or an instruction in a form of software. The processor may be a general processor, a digital signal processor (Digital Signal Processor, DSP), an application specific integrated circuit (Application Specific Integrated Circuit, ASIC), a field programmable gate array (Field Programmable Gate Array, FPGA) or other programmable logic devices, a discrete gate or a transistor logic device, and a discrete hardware component. The methods, steps and logical diagrams disclosed in the embodiments of the present application may be implemented or executed. The general processor may be a microprocessor or the processor may also be any conventional processor or the like. The steps of the method disclosed in the embodiments of the present application may be directly executed by a hardware decoding processor, or by a combination of the hardware and software modules in the decoding processor. The software modules may be located in a mature storage medium in the art, i.e. a random memory, a flash memory, a read-only memory, a programmable read-only memory, or an electrically erasable programmable memory, a register, etc. The storage medium is located in a memory, the processor reads information in the memory, and completes the steps of the above methods in combination with hardware thereof.

It can be understood that, the memory in the embodiments of the present application may be a volatile memory or a non-volatile memory, or may include both a volatile memory and a non-volatile memory. The non-volatile memory may be a read-only memory (Read-Only Memory, ROM), a programmable read-only memory (Programmable ROM. PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), which functions as an external cache. Description is illustrative but not restrictive, RAM in many forms may be available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM, an enhanced synchronous dynamic random access memory (Enhanced SDRAM, ESDRAM), a synchronous connection dynamic random access memory (Synchlink DRAM, SLDRAM) and a direct Rambus random access memory (Direct Rambus RAM, DR RAM). It should be noted that, the memory in the systems and methods described herein is intended to include, but is not limited to, these and any memory in other suitable types.

It should be understood that, description of the above memory is illustrative but not restrictive. For example, the memory in the embodiments of the present application may also be a static random access memory (SRAM), a dynamic random access memory (DRAM), a synchronous dynamic random access memory (SDRAM), a double data rate synchronous dynamic random access memory (DDR SDRAM, an enhanced synchronous dynamic random access memory (ESDRAM), a synchronous connection dynamic random access memory (SLDRAM) and a direct Rambus random access memory (DR RAM) and the like. That is, the memory in the embodiments of the present application is intended to include, but is not limited to, these and any memory in other suitable types.

An embodiment of the present application further provides a computer readable storage medium for storing a computer program.

In an embodiment, the computer readable storage medium may be applied to a network device in the embodiments of the present application, and the computer program may cause a computer to execute corresponding processes implemented by the network device in various methods in the embodiments of the present application. It is not described herein for simplicity.

In an embodiment, the computer readable storage medium may be applied to a terminal device in the embodiments of the present application, and the computer program may cause a computer to execute corresponding processes implemented by the terminal device in various methods in the embodiments of the present application. It is not described herein for simplicity.

An embodiment of the present application further provides a computer program product which includes computer program instructions.

In an embodiment, the computer program product may be applied to a network device in the embodiments of the present application, and the computer program instructions may cause a computer to execute corresponding processes implemented by the network device in various methods in the embodiments of the present application. It is not described herein for simplicity.

In an embodiment, the computer program product may be applied to a mobile terminal/a terminal device in the embodiments of the present application, and the computer program instructions may cause a computer to execute corresponding processes implemented by the mobile terminal/the terminal device in various methods in the embodiments of the present application. It is not described herein for simplicity.

An embodiment of the present application further provides a computer program.

In an embodiment, the computer program may be applied to a network device in the embodiments of the present application, when the computer program is run on a computer, the computer may be caused to execute corresponding processes implemented by the network device in various methods in the embodiments of the present application. It is not described herein for simplicity.

In an embodiment, the computer program may be applied to a mobile terminal/a terminal device in the embodiments of the present application, when the computer program is run on a computer, the computer may be caused to execute corresponding processes implemented by the mobile terminal/the terminal device in various methods in the embodiments of the present application. It is not described herein for simplicity.

Persons of ordinary skill in the art may realize that, the units and algorithm steps described in the embodiments disclosed herein may be implemented in electronic hardware, or a combination of computer software and electronic hardware. Whether these functions are executed in a manner of hardware or software depends on the particular application and design constraints of the technical solution. Professionals may use different methods for each particular application to implement the described functions, but such implementations should not be considered to be beyond the scope of the present application.

A person skilled in the pertinent art may clearly understand that, for the convenience and simplicity of description, the specific working processes of the systems, apparatuses and units described above may refer to the corresponding processes in the foregoing method embodiments, and are not described herein again.

In the several embodiments provided in the present application, it should be understood that, the disclosed systems, apparatuses and methods may be implemented in other manners. For example, the apparatus embodiments described above are merely schematic. For example, the division of the units is merely a logical function division, and there may be another division manner in an actual implementation. For example, a plurality of units or components may be combined or integrated in another system, or some features may be ignored or not performed. In another point, the displayed or discussed coupling to each other or direct coupling or a communication connection may be through some interfaces. Indirect coupling or a communication connection of the devices or the units may be electrical, mechanical or in other forms.

The units described as separate components may or may not be physically separate, and the components displayed as units may or may not be physical units, that is, may be located in one place, or may be distributed to a plurality of network units. Some or all of the units may be selected according to actual needs to achieve the purpose of the solution of the present embodiment.

In addition, each functional unit in each embodiment of the present application may be integrated in one processing unit, or each unit may be physically present separately, or two or more units may be integrated in one unit.

The above are merely specific embodiments of the present application, but the protection scope of the present application is not limited thereto. Any variation or replacement readily conceivable by a person skilled in the art within the technical scope disclosed in the present application should be covered within the protection scope of the present application. Therefore, the protection scope of the present application should be defined by the protection scope of the claims.

What is claimed is:

1. A synchronization indication method, which is applied to a terminal device, comprising:
receiving synchronization indication information sent by a source network device;
wherein the synchronization indication information is configured to assist the terminal device in acquiring at least one of the following:
a timing advance (TA) value between the terminal device and the source network device; a TA value between the terminal device and a target network device; or a difference between a TA between the terminal device and the source network device and a TA between the terminal device and the target network device.

2. The method according to claim 1, wherein the synchronization indication information is carried by a radio resource control (RRC) message.

3. The method according to claim 2, wherein the RRC message comprises at least a reconfiguration message and a handover command.

4. The method according to claim 1, wherein the synchronization indication information further comprises at least one of the following:
a TA value of the terminal device on a target network device side;
TA offset values of the terminal device at the source network device and the target network device; or
a TA adjusting factor.

5. The method according to claim 1, wherein the method further comprises:
receiving indication information sent by the source network device;
wherein the indication information comprises at least one of the following:
a time boundary between the terminal device and the source network device and a time boundary between the terminal device and the target network device; or
a difference between a time boundary between the terminal device and the source network device and a time boundary between the terminal device and the target network device.

6. The method according to claim 5, wherein after the receiving indication information sent by the source network device, the method further comprises:
determining, based on the indication information and/or the synchronization indication information, at least one of the following:
the TA value between the terminal device and the source network device; the TA value between the terminal device and the target network device; or the difference between the TA between the terminal device and the source network device and the TA between the terminal device and the target network device.

7. A synchronization indication method, which is applied to a terminal device, comprising:
sending synchronization indication information to a network device;
wherein the synchronization indication information is configured to assist the network device in acquiring at least one of the following:
a timing advance (TA) value between the terminal device and a source network device; a TA value between the terminal device and a target network device; or a difference between a TA between the terminal device and the source network device and a TA between the terminal device and the target network device.

8. The method according to claim 7, wherein the synchronization indication information is carried by a radio resource control (RRC) message.

9. The method according to claim 8, wherein the RRC message comprises at least a measurement report message.

10. The method according to claim 7, wherein the synchronization indication information further comprises at least one of the following:
a signal measurement difference of the terminal device at the source network device and the target network device;
a difference between a distance between the terminal device and the source network device and a distance between the terminal device and the target network device;
TA value information between the terminal device and the network device;
an identifier of the target network device; or
an identifier of a candidate target network device selected by the terminal device.

11. A synchronization indication method, which is applied to a terminal device, comprising:
receiving synchronization indication information sent by a network device;
wherein the synchronization indication information is configured to configure the terminal device to measure a candidate target network device, so as to assist the network device in acquiring at least one of the following:
a timing advance (TA) value between the terminal device and a source network device; a TA value between the terminal device and the candidate target network device; or a difference between a TA between the terminal device and the source network device and a TA between the terminal device and the candidate target network device.

12. The method according to claim 11, wherein the synchronization indication information is carried by a radio resource control (RRC) message wherein the RRC message comprises but is not limited to a reconfiguration message and a handover command.

13. The method according to claim 11, wherein the synchronization indication information comprises at least one of the following:
an identifier of the candidate target network device;
a configuration of a measurement object; or
a report configuration.

14. The method according to claim 11, wherein after the receiving synchronization indication information sent by a network device, the method further comprises:
measuring the candidate target network device based on the synchronization indication information to obtain a measurement result; and
determining, based on the measurement result, at least one of the following:
the TA value between the terminal device and the source network device; the TA value between the terminal device and the candidate target network device; or the difference between the TA between the terminal device and the source network device and the TA between the terminal device and the candidate target network device.

15. A terminal device, comprising: a processor and a memory which is configured to store a computer program runnable on the processor, wherein the memory is configured to store the computer program, and the processor is configured to invoke and run the computer program stored in the memory, and execute steps of the method according to claim 1.

16. A terminal device, comprising: a processor and a memory which is configured to store a computer program runnable on the processor, wherein the memory is configured to store the computer program, and the processor is configured to invoke and run the computer program stored in the memory, and execute steps of the method according to claim 7.

17. A terminal device, comprising: a processor and a memory which is configured to store a computer program runnable on the processor, wherein the memory is configured to store the computer program, and the processor is configured to invoke and run the computer program stored in the memory, and execute steps of the method according to claim 11.

18. A computer readable storage medium, the computer readable storage medium is configured to store a computer program, and the computer program is configured to cause a computer to execute steps of the method according to claim 1.

19. A computer readable storage medium, the computer readable storage medium is configured to store a computer program, and the computer program is configured to cause a computer to execute steps of the method according to claim 7.

20. A computer readable storage medium, the computer readable storage medium is configured to store a computer program, and the computer program is configured to cause a computer to execute steps of the method according to claim 11.
